(19) United States
(12) Patent Application Publication
(10) Pub. No.: US 2022/0382300 A1
(43) Pub. Date: Dec. 1, 2022

(54) Determining Characteristics of a Water Surface Beneath a Vehicle in Motion

(71) Applicant: REGENT Craft Inc., Burlington, MA (US)

(72) Inventors: David Larson, Medford, MA (US); Michael Klinker, Hollis, NH (US); William Bryan Baker, Cohasset, MA (US)

(21) Appl. No.: 17/875,942

(22) Filed: Jul. 28, 2022

Related U.S. Application Data
(63) Continuation-in-part of application No. 17/845,480, filed on Jun. 21, 2022.
Application No. 17/845,480 is a continuation-in-part of application No. 17/570,090, filed on Jan. 6, 2022, now Pat. No. 11,420,738.
Application No. 17/845,480 is a continuation-in-part of application No. 17/570,090, filed on Jan. 6, 2022, now Pat. No. 11,420,738.
(60) Provisional application No. 63/148,565, filed on Feb. 11, 2021.
(60) Provisional application No. 63/281,594, filed on Nov. 19, 2021.

(51) Int. Cl. G05D 1/10; G05D 1/04; H04N 5/232; G01S 17/894; G01S 17/933

(52) U.S. Cl. CPC G05D 1/106; G05D 1/042; H04N 5/232121; G01S 17/894; G01S 17/933; B64D 27/24

(57) ABSTRACT

An example computing system is configured to: (i) receive, from one or more sensors of a vehicle in motion over a body of water, a set of sensor data, (ii) based on the set of sensor data, determine (a) an instantaneous distance between the vehicle and a surface of the body of water and (b) an instantaneous slope of the surface of the body of water, (iii) based on at least one of the instantaneous distance or the instantaneous slope, determine a statistical representation of the surface of the body of water, and (iv) based on the determined statistical representation of the surface of the body of water, adjust one or more control surfaces of the vehicle to change one or more of a speed, altitude, heading, or attitude of the vehicle.

### CROSS-REFERENCE TO RELATED APPLICATIONS

This application is a continuation-in-part of, and claims the benefit of priority under 35 U.S.C. § 120 to, U.S. patent application Ser. No. 17/570,090, filed on Jan. 6, 2022, which claims priority to U.S. Provisional Patent App. No. 63/148,565, filed on Feb. 11, 2021, and U.S. Provisional Patent App. No. 63/281,594, filed on Nov. 19, 2021. This application is also a continuation-in-part of, and claims the benefit of priority under 35 U.S.C. § 120 to, U.S. patent application Ser. No. 17/845,480, filed on Jun. 21, 2022, which is a continuation-in-part of U.S. patent application Ser. No. 17/570,090, filed on Jan. 6, 2022, which claims priority to U.S. Provisional Patent App. No. 63/148,565, filed on Feb. 11, 2021, and U.S. Provisional Patent App. No. 63/281,594, filed on Nov. 19, 2021. The contents of each of the foregoing applications are incorporated by reference herein in their entireties.

### FIELD OF THE DISCLOSURE

This disclosure is related to technology for determining various characteristics of a water surface and using the determined characteristics as a basis for controlling the operation of a vehicle in motion above the water surface.

### BACKGROUND

Various different vehicles are capable of traveling over water while remaining close to the surface of the water. One example of such a vehicle is a wing-in-ground effect vehicle (WIG), which can include an aerodynamic surface which is designed to operate close to the water surface in aerodynamic ground-effect. Other examples may include various other aircraft, such as helicopters.

### BRIEF DESCRIPTION OF THE DRAWINGS

Features, aspects, and advantages of the presently disclosed technology may be better understood with regard to the following description, appended claims, and accompanying drawings where:

FIG. 1A depicts a perspective view of an example WIG, according to an example embodiment;

FIG. 1B depicts a top view of an example WIG;

FIG. 1C depicts a side view of the example WIG;

FIG. 1D depicts a front view of the example WIG;

FIG. 1E depicts a front perspective view of an example WIG having a multi-airfoil tail, according to an example embodiment;

FIG. 1F depicts a rear perspective view of the example WIG of FIG. 1E;

FIG. 1G depicts a side view of the example WIG of FIG. 1E;

FIG. 2 depicts a main hydrofoil deployment system of the example WIG;

FIG. 3A depicts a rear hydrofoil deployment system of the example WIG;

FIG. 3B depicts the rear hydrofoil deployment system of the example WIG;

FIG. 4 depicts a control system of the example WIG; and

FIG. 5 depicts various operational modes of the example WIG.

FIG. 6 depicts a flowchart of an example process for using adjustable focal length image sensors to determine various characteristics of a water surface beneath a vehicle in motion.

FIG. 7 depicts a flowchart of an example process for using time-of-flight image sensors to determine various characteristics of a water surface beneath a vehicle in motion.

FIG. 8 depicts a flowchart of an example process for using wing deflection sensors to determine various characteristics of a water surface beneath a vehicle in motion.

FIG. 9 depicts a simplified diagram of an example distributed sensor array.

FIG. 10 depicts a flowchart of an example process for determining various characteristics of a water surface beneath a vehicle in motion and controlling operation of the vehicle.

The drawings are for the purpose of illustrating example embodiments, and it is to be understood that the present disclosure is not limited to the arrangements and instrumentalities shown in the drawings.

### DETAILED DESCRIPTION

### I. Overview

Vehicles operating at low altitudes over water surfaces experience unique conditions that other vehicles operating at higher altitudes or over different terrains experience. For instance, ocean waves occur in an earth-fixed (i.e., still) reference frame and typically have energy within a finite frequency bandwidth (effectively between 0 and 5 Hz). However, when the reference frame is not fixed but is instead that of a vehicle traveling with non-zero forward speed such as a ship or wing-in-ground effect vehicle, the observed frequency of the wave that the vehicle experiences is doppler shifted, both as a function of speed and heading with respect to the waves. Namely, the observed frequency of the waves encountered by the vehicle is given by the following equation:

ω_{encounter}=ωₑₐᵣₜₕ−Uk cos(β)

where ω_{encounter} is the frequency of wave oscillation the vehicle experiences, ωₑₐᵣₜₕ is the earth-frame frequency the geophysical waves are oscillating at (as if observed by an observer standing still on a beach), k is the wave number, which is a property of the wave itself (not relating in any way to the vehicle or how it is moving, but related to the water depth, frequency of oscillation, and potentially other geophysical parameters), U is the forward speed of the vehicle, and β is the wave heading with respect to the vehicle, defined such that β=0 radians when the waves are propagating in the same direction as the vehicle (also referred to as following waves), β=π/2 when the waves are propagating orthogonally to the direction of travel (also referred to as beam or side waves) and β=π when the waves are propagating in the opposite direction as the vehicle (also referred to as head waves). Inspecting this relationship reveals how, when controlling a vehicle in a wavy environment, not only does altitude play a major role in the magnitude and frequency of excitations (and ability to move away from resonant peaks), but so does the speed and the heading of the vehicle.

The technologies described herein may help control a vehicle under these unique conditions experienced by WIGs or other vehicles operating at low altitudes over water surfaces. For instance, the present disclosure describes various examples of sensor systems and processes for measuring characteristics of a water surface beneath a vehicle in motion and using the measured characteristics as a basis for controlling operation of the vehicle. While the examples described herein are primarily described in connection with a WIG in airborne flight over the water surface or in hydrofoil-borne motion over the water surface, it should be understood that these examples may also be implemented in connection with other types of vehicles in other types of motion near a water surface where possible. For instance, in some examples, the sensor systems and processes described herein may be implemented in connection with a hydrofoil-borne watercraft in motion through a body of water with its hull lifted above the water surface due to the hydrodynamic lift force exerted on the watercraft's hydrofoil. In other examples, the sensor systems and processes described herein may be implemented in connection with an aircraft in flight above a body of water, such as a helicopter flying near the surface of the water. Still other examples may be possible as well.

### II. Example Wing-In-Ground Effect Vehicles

In addition to the examples described herein, various examples of WIGs and their components are described in U.S. patent application Ser. No. 17/570,090, filed on Jan. 6, 2022 and titled “Wing-In-Ground Effect Vehicle,” and U.S. patent application Ser. No. 17/845,480, filed on Jun. 21, 2022 and titled “Airborne Vehicle with Multi-Airfoil Tail,” which, as noted above, are incorporated herein by reference in their entireties.

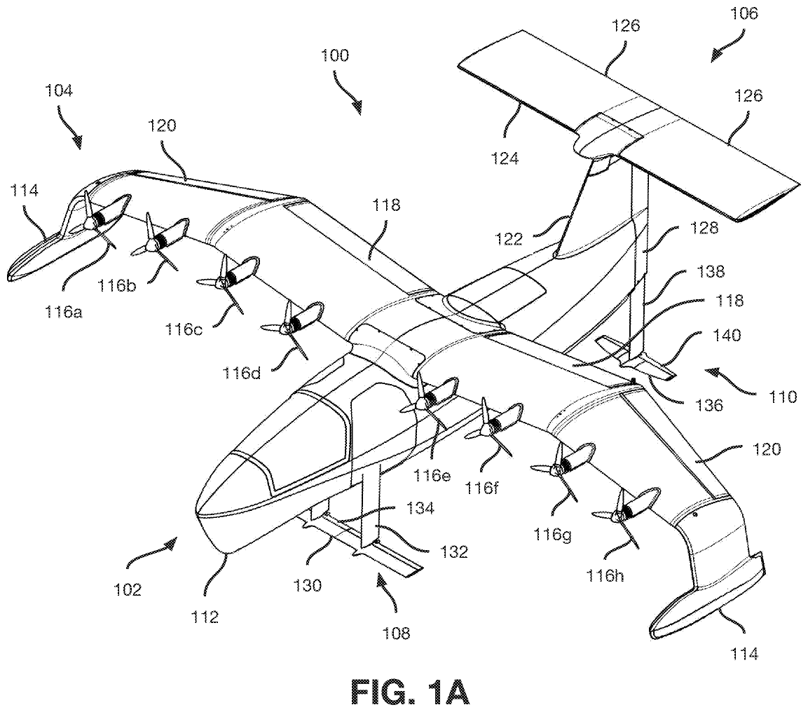

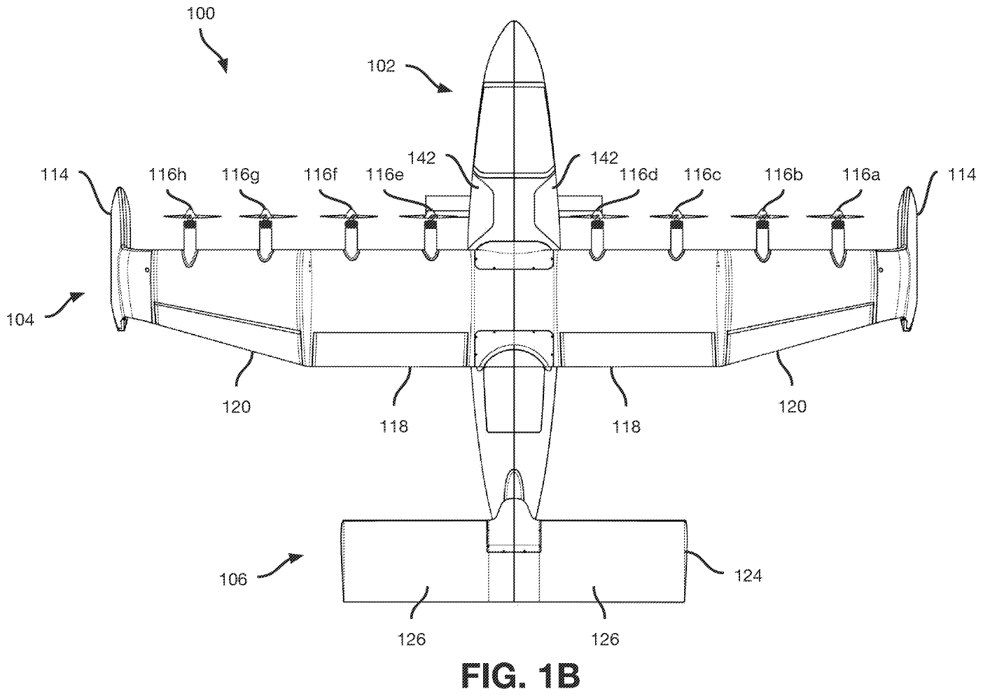

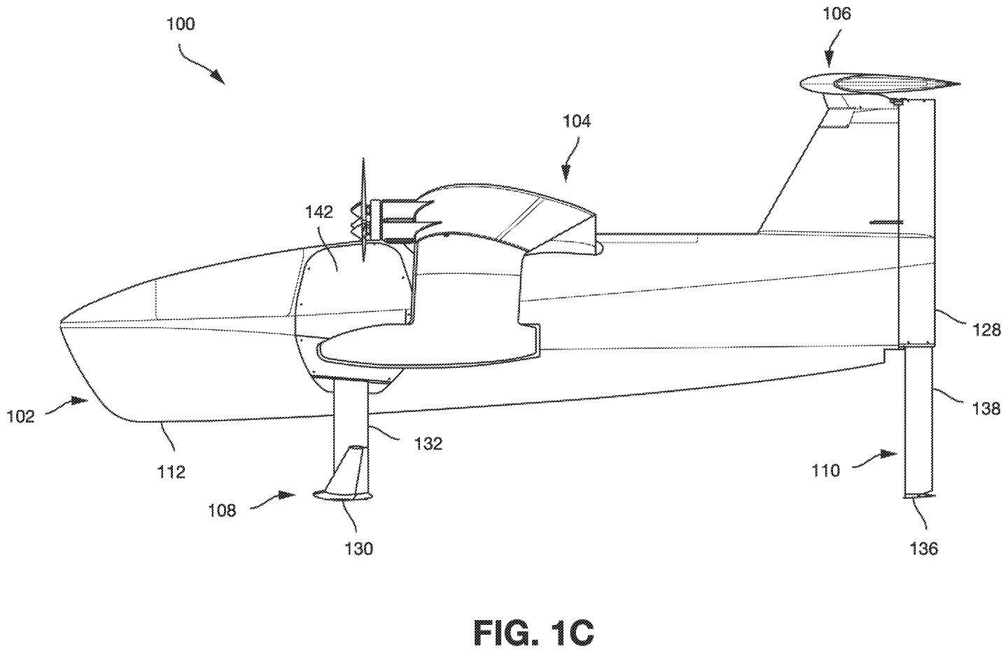

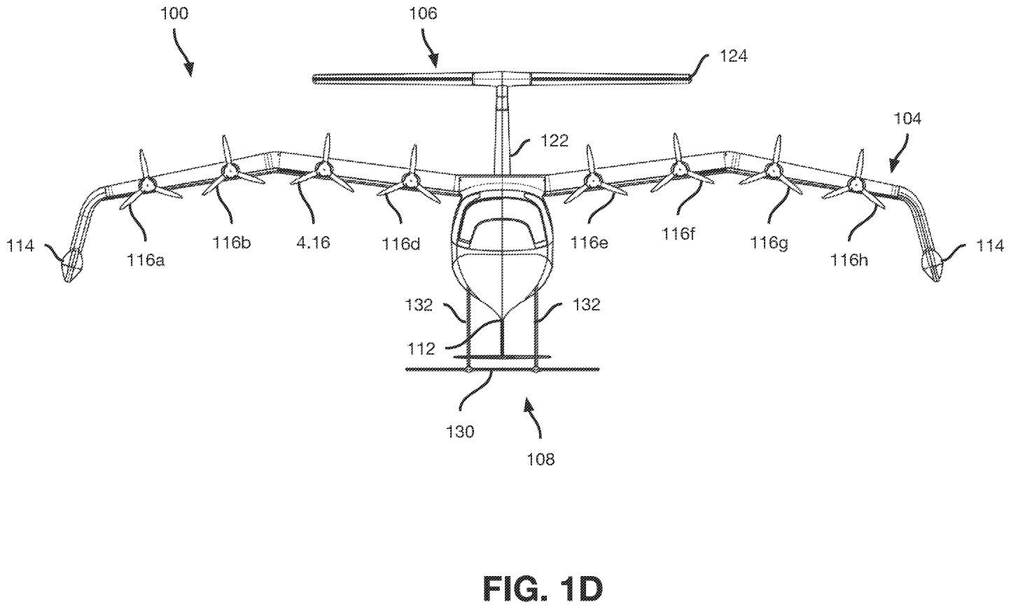

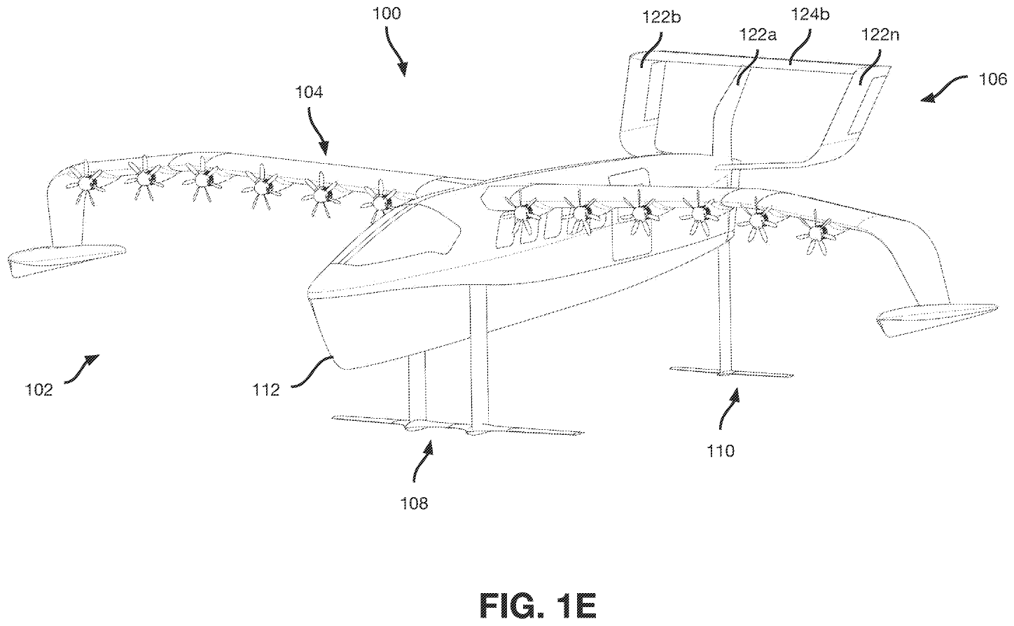

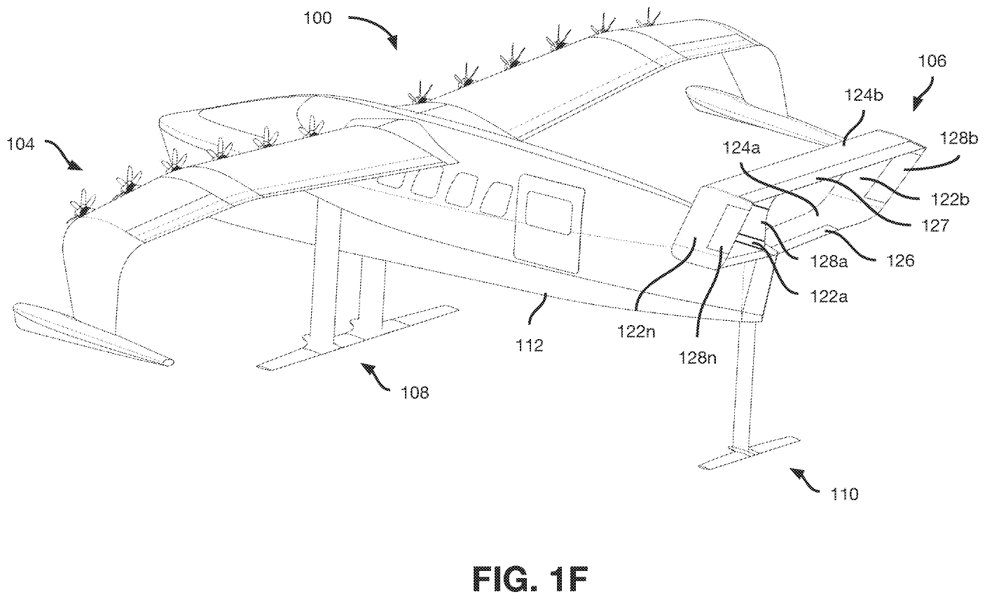

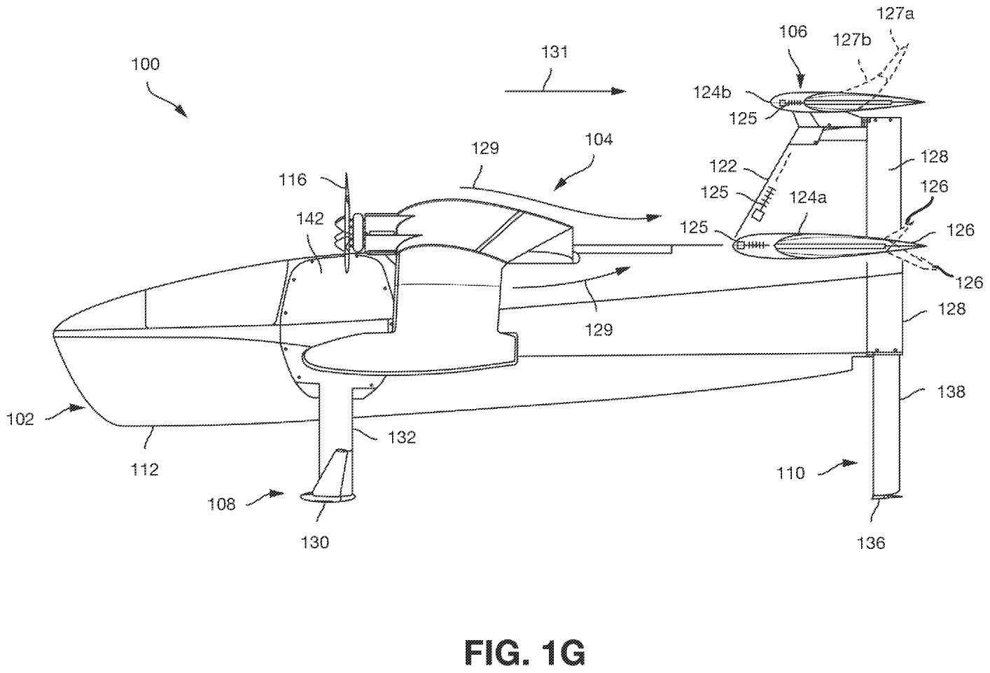

FIGS. 1A-1D depict different views of an example WIG 100, including a perspective view in FIG. 1A, a top view in FIG. 1B, a side view in FIG. 1C, and a front view in FIG. 1D. As shown in these various views, the WIG 100 includes a hull 102, a main wing 104, a tail 106, a main hydrofoil assembly 108, and a rear hydrofoil assembly 110.

A. Hull

In line with the discussion above and as further described below, the WIG 100 is capable of operating in a first waterborne mode for extended periods of time, during which the hull 102 is at least partially submerged in water. As such, the hull 102 may be designed to be watertight, particularly for surfaces of the hull that contact the water during this first waterborne operational mode. Further, the hull 102, as well as the entirety of the WIG 100, is configured to be passively stable on all axes when floating in calm water. To help achieve this, the hull 102 may include a keel (or centerline) 112 which may provide improved stability and other benefits described below. And in some examples, the WIG 100 may include various mechanisms for adjusting the center of mass of the WIG 100 so that the center of mass aligns with the center of buoyancy of the WIG 100. One way to achieve this is to couple a battery system of the WIG 100 to one or more moveable mounts that may be moved by one or more servo motors or the like. A control system of the WIG 100 may detect a change in its center of buoyancy, for instance by detecting a rotational change via an onboard gyroscope, and the control system may responsively operate the servo motors to move the battery system until the gyroscope indicates that the WIG 100 has stabilized. Another way to adjust the center of mass of the WIG 100 so that the center of mass aligns with the center of buoyancy of the WIG 100 is to include a ballast system for pumping water or air to various tanks distributed throughout the hull 102 of the WIG 100, which may allow for adjusting the center of mass of the WIG 100 in a similar manner as moving the battery system. Other example systems may be used to control the center of mass of the WIG 100 as well.

Additionally, the hull 102 may be designed to reduce drag forces when both waterborne and airborne. For instance, the hull 102 may have a high length-to-beam ratio (e.g., greater than or equal to 8), which may help reduce hydrodynamic drag forces when the WIG 100 is under forward waterborne motion. In some examples, the keel 112 may be curved or rockered to improve maneuverability when waterborne. Further, the hull 102 may be designed to pierce the surface of waves (e.g., to increase passenger and crew comfort) by including a narrow, low-buoyancy bow portion of the hull 102.

B. Wing and Distributed Propulsion System

The main wing 104 may also include features to improve stability of the WIG 100 during waterborne operation. For instance, as shown in FIGS. 1A-1D, the main wing 104 may include an outrigger 114 at each end of the main wing 104. The outriggers 114 (which are sometimes referred to as “wing-tip pontoons”) are configured to provide a buoyant force to the main wing 104 when submerged or when otherwise in contact with the water. As depicted in the front view of the WIG 100 in FIG. 1D, the main wing 104 may be designed to have a gull wing shape such that the outriggers 114 at the ends of the main wing 104 are at the lowest point of the main wing 104 and are positioned approximately level with (or slightly above) a waterline of the hull 102 when the hull 102 is waterborne.

As best shown in the top view of the WIG 100 in FIG. 1B, the main wing 104 is designed to have a high aspect ratio, which represents the ratio of the span of the main wing 104 to the mean chord of the main wing 104. In some examples, the aspect ratio of the main wing 104 is greater than or equal to five, or greater than or equal to six, but other example aspect ratios are possible as well.

High aspect ratio wings may provide certain drawbacks when compared to low aspect ratio wings, including reduced pitch stability due to a shorter mean chord. Previous WIGs have opted for low aspect ratio wings to address these instability issues. For instance, when a WIG is flying in ground-effect, there is an increase in static pressure underneath the wings, which shifts the aerodynamic center of the WIG backward and causes aerodynamic instability in the WIG's pitch axis. Low aspect ratio wings focus the lift force on the leading edge of the wing, and when the WIG pitches upward the leading edge also pitches upward, causing the WIG to leave ground-effect, lose lift, and settle back down. However, while this low aspect ratio wing design addressed instability issues, it significantly reduced the aerodynamic efficiency of these previous WIG designs.

Another drawback of high aspect ratio wings, generally, is their reduced maneuverability due to a lower roll angular acceleration. And the maneuverability of high aspect ratio wings may be further reduced for WIGs. For instance, when operating in a ground-effect flight mode over a water surface, a WIG with a high aspect ratio wing may be close enough to the water surface that too much roll could cause the wing to collide with the water surface. To address these and other issues, the WIG 100 disclosed herein may include various additional mechanisms, as described in further detail below, for improving its maneuverability to compensate for the reduced maneuverability resulting from the high aspect ratio of the main wing 104.

While high aspect ratio wings may provide various drawbacks, such as those identified above, high aspect ratio wings may also provide a number of improvements over low aspect ratio wings, including increased roll stability and increased efficiency resulting from higher lift-to-drag ratios. Further, another benefit of a high aspect ratio wing is that it provides a longer leading edge for mounting a distributed propulsion system along the wing. Arranging propulsion systems in this distributed manner along the wing provides a “blown-wing” propulsion system in which the propulsion systems can increase the velocity of air moving over the wing, and the increased air velocity over the main wing increases the lift generated by the main wing. This increase in lift can enable the WIG to takeoff and become airborne at slower speeds, which can be especially advantageous for takeoff of waterborne WIGs. For instance, waterborne WIGs may be subjected to various forces that limit their takeoff speed, such as water resistance and reduced lift caused by cavitation when operating on one or more hydrofoils, as explained in further detail below.

As shown in FIGS. 1A-1D, the main wing 104 includes a number of electric motor propeller assemblies 116 distributed across a leading edge of the main wing 104. Arranging the propeller assemblies 116 in this manner can increase the velocity of air moving over the main wing 104, and the increased air velocity over the main wing 104 increases the lift generated by the main wing 104. This increase in lift can enable the WIG 100 to take off and become airborne at slower vehicle speeds.

The distributed blown-wing arrangement of the electric motor propeller assemblies 116 improves upon arrangements in existing WIGs, which have relied on one or more liquid-fueled engines as the primary propulsion source during operation. Liquid-fueled engines are typically much heavier, more complex, and larger than electric motors, so any benefits of additional lift provided by a distributed blown-wing arrangement of liquid-fueled engines may be outweighed by the additional weight and complexity of multiple engines. Further, coupling an array of propellers to the liquid-fueled engines may require multiple rotating shafts and gearboxes, thereby increasing the mechanical complexity and resultant maintenance costs to the point of unfeasibility. Using the electric motor propeller assemblies 116, however, alleviates such issues. Each individual electric motor propeller assembly 116 can be controlled by an electronic speed controller and powered by an onboard battery system, such as, for example, a lithium-ion, magnesium-ion, or lithium-sulfur system, or by some other onboard electrical supply system, such as a fuel cell or a centralized liquid-fueled electricity generator. In some examples, the onboard electrical supply system may include multiple systems for supplying power during different operational modes, such as a first battery system configured to deliver large amounts of power during takeoff and a second system with a higher energy density but lower peak power capability for delivering sustained lower power during cruise operation (e.g., during hydrofoil waterborne operation or during airborne operation).

The positioning of the electric motor propeller assemblies 116 along the leading edge of the main wing 104 may be determined based on a variety of factors including, but not limited to, (i) the required total thrust for all modes of operation of the WIG 100, (ii) the thrust generated by each individual propeller assembly 116, (iii) the radius of each propeller in the respective propeller assemblies 116, (iv) the required tip clearance between each propeller and the surface of the water, and (v) the additional freestream velocity over the main wing 104 required for operation. As shown in FIGS. 1A-1D, the number of propeller assemblies 116 is symmetrical across both sides of the hull 102. The propeller assemblies 116 may all be identical, or they may have different propeller radii or blade configurations along the span so long as the configuration is symmetrical across the hull 102. One advantage for having different propeller assembly 116 radii is allowing adequate propeller tip clearance from the water or vehicle structure. An advantage of having different blade configurations on the propeller assemblies 116 is to allow some propellers to be optimized for different operational conditions, such as airborne cruise. The propeller placement and configuration may vary to increase the airflow over the main wing 104 or tail system 106 to improve controllability or stability. While FIGS. 1A-1D depict an example WIG 100 having eight total propeller assemblies 116, the actual number of propeller assemblies 116 can vary based on the requirements of the WIG 100.

In some examples, the respective propeller assemblies 116 may have different pitch settings or variable pitch capabilities based on their position on the main wing 104. For instance, a subset of the propeller assemblies 116 may have fixed-pitch propellers sized for cruise speeds, while the remainder of the propeller assemblies 116 can have fixed-pitch propellers configured for takeoff, or can allow for varying of the propeller's pitch. Additionally, different propeller assemblies 116 may be turned off or have reduced rotational speeds during different modes of operation. For instance, during waterborne operation, one or more of the propeller assemblies 116 may be turned off or have reduced rotational speeds in a manner that generates asymmetrical thrust. This may create a yawing moment on the WIG 100, allowing the WIG 100 to turn without large bank angles and increasing the turning maneuverability of the WIG 100. For instance, in order to yaw right, the WIG 100 may increase the rotational speeds of the propellers of one or more of propeller assemblies 116e-h while decreasing the rotational speeds of the propellers of one or more of propeller assemblies 116a-d. Similarly, in order to yaw left, the WIG 100 may increase the rotational speeds of the propellers of one or more of propeller assemblies 116a-d while decreasing the rotational speeds of the propellers of one or more of propeller assemblies 116e-h.

The main wing 104 may further include one or more aerodynamic control surfaces, such as flaps 118 and ailerons 120, which may comprise movable hinged surfaces on the trailing or leading edges of the main wing 104 for changing the aerodynamic shape of the main wing 104. The flaps 118 may be configured to extend downward below the main wing 104 in order to reduce stall speed and create additional lift at low airspeeds, while the ailerons 120 may be configured to extend upward above the main wing 104 in order to decrease lift on one side of the main wing 104 and induce a roll moment in the WIG 100. In some examples, the ailerons 120 may be additionally configured to extend downward below the main wing 104 in a flaperon configuration to help the flaps 118 generate additional lift on the main wing 104, which may be used to either create a rolling moment or additional balanced lift depending on coordinated movement of both ailerons. The flaps 118 and ailerons 120 may each include one or more actuators for raising and lowering the flaps 118 and ailerons 120. The flaps 118 may include, for example, one or more of plain flaps, split flaps, slotted flaps, Fowler flaps, slotted Fowler flaps, Gouge flaps, Junkers flaps, or Zap flaps. Further, the flaps 118 (and the ailerons 120 when configured as flaperons) should be positioned so that they are in the wake of one or more of the propeller assemblies 116. The ailerons 120 may be positioned so that they are in the wake of one or more of the propeller assemblies 116 in order to increase the effectiveness of the ailerons at low forward velocities. Some of the propeller assemblies 116 may be positioned so that no ailerons 120 are in their wake to increase thrust on the outboard wing during a turn without inducing adverse yaw. For example, in a left turn, a normal airplane would have adverse yaw to the right as the right aileron is deflected down, increasing drag. In the present disclosure, however, the right propeller assembly outboard of the right aileron may have its thrust increased relative to the respective left propeller assembly, initiating a turn without adverse yaw.

C. Tail System

In some examples, as illustrated in FIGS. 1A-1D, the tail 106 includes a vertical stabilizer 122, a horizontal stabilizer 124, and one or more control surfaces, such as elevators 126. Similar to the flaps 118 and ailerons 120, the elevators 126 may comprise movable hinged surfaces on the trailing or leading edges of the horizontal stabilizer 124 for changing the aerodynamic shape of the horizontal stabilizer 124 to control a pitch of the WIG 100. The horizontal stabilizer 124 may be combined with the elevator 126, creating a fully articulating horizontal stabilizer. Raising the elevators 126 above the hinge point creates a net downward force on the tail system and causes the WIG 100 to pitch upward. Lowering the elevators 126 below the hinge point creates a net upward force on the horizontal stabilizer 124 and causes the WIG 100 to pitch downward. The elevators 126 may include actuators, which may be operated by a control system of the WIG 100 in order to raise and lower the elevators 126.

In the examples illustrated in FIGS. 1A-1D, the tail 106 may further include a rudder 128. The rudder 128 may comprise a movable hinged surface on the trailing edge of the vertical stabilizer 122 for changing the aerodynamic shape of the vertical stabilizer 122 to control the yaw of the WIG 100 when operating in an airborne mode. In some examples, the rudder 128 may additionally change a hydrodynamic shape of the hull 102 to control the yaw of the WIG 100 when operating in a waterborne mode. In order to facilitate such hydrodynamic control, the rudder 128 may be positioned low enough on the tail 106 that the rudder 128 is partially or entirely submerged when the hull 102 is floating in water. Namely, the rudder 128 may be positioned partially or entirely below a waterline of the hull 102. The rudder 128 may include one or more actuators, which may be operated by a control system of the WIG 100 in order to rotate the hinged surface of the rudder 128 to the left or right of the vertical stabilizer 122. Actuating the rudder 128 to the left (relative to the direction of travel) causes the WIG 100 to yaw left. Actuating the rudder 128 to the right (relative to the direction of travel) causes the WIG 100 to yaw right. As such, the rudder 128 may be used in combination with any of the other mechanisms disclosed herein for controlling the yaw of the WIG 100, including in combination with the ailerons 120 during airborne operation and in combination with varying the rotational speeds of different ones of the propeller assemblies 116 to help improve maneuverability of the WIG 100 during waterborne operation.

In some examples, as illustrated in FIGS. 1E-1G, the tail 106 includes one or more vertical stabilizers 122a, 122b, 122n, one or more horizontal stabilizers 124a, 124b, one or more control surfaces, such as elevators 126, and one or more tail flaps 127a, 127b for enhanced pitch control configured to exert enhanced net downward force on the tail system. It should be understood that although FIGS. 1E-1G show only two horizontal stabilizers and two tail flaps, it is contemplated that more than two of each can be used within the scope of the present teachings. In some applications it has been found that the transition from waterborne operation to airborne or wing-borne operation can require a larger pitching moment to overcome the larger drag forces existing between the hull 102 and/or the hydrofoil assemblies 108, 110 and the water. This phenomenon can further occur in wheeled aircraft configured for short takeoff and landing (STOL) operations. In this way, at low airspeeds, aerodynamic forces in conventional designs fail to produce sufficient downward force to permit sufficient pitching moment. To provide sufficient pitching moment to pitch the WIG 100 upward, a conventional solution would be to increase the span of the tail so that the elevator generates more force; however, a resultant consequence of increasing the span of the tail is that the entire tail must be stronger and heavier, which can result in undesired reduction of payload and efficiency. However, the present configuration provides improved performance by providing a tail 106 having a first horizontal stabilizer 124a and a second horizontal stabilizer 124b. It should be understood that one or more additional horizontal stabilizers can be used.

In some examples, a first horizontal stabilizer 124a can be a lower horizontal stabilizer relative to a second horizontal stabilizer 124b. However, it should be appreciated that the horizontal stabilizers in some examples can be interchanged for performance purposes (e.g., the disclosed structure of the first horizontal stabilizer 124a can be incorporated in the upper horizontal stabilizer and the disclosed structure of the second horizontal stabilizer 124b can be incorporated in the lower horizontal stabilizer). In some non-limiting examples, structure, shape, and/or performance of each horizontal stabilizer can be tailored as desired such that the lower horizontal stabilizer (in this example, the first horizontal stabilizer 124a) is more likely to experience aerodynamic effect from being in the wake of the blown-wing propulsion system disclosed herein or associated wake produced by alternative propulsion systems. In this way, greater aerodynamic control and/or downward lift can be generated during desired phases of operation.

In some examples, horizontal stabilizers 124a, 124b can include one or more aerodynamic control surfaces, such as tail flaps 127 and elevators 126, which may comprise movable hinged surfaces on the trailing or leading edges of the horizontal stabilizer 124 for changing the aerodynamic shape of the respective horizontal stabilizer 124. It should be recognized that at least one of the horizontal stabilizers 124a, 124b can be sized, shaped, and/or spaced relative to a second of the horizontal stabilizers 124a, 124b to enhance or minimize the aerodynamic effect on the adjacent stabilizers. In this way, the aerodynamic flow, pressures, and/or forces can be used to improve the efficiency or effectiveness of the adjacent stabilizer. In some examples, at least one of the horizontal stabilizers 124a, 124b can be actuated in an opposing direction. In some embodiments, at least one of the horizontal stabilizers 124a, 124b can define a ratio of a surface area of the first horizontal stabilizer to a surface area of the second horizontal stabilizer in the range of 0.9 to 1.6. In some exemplary configurations and by non-limiting example, the surface area of the first horizontal stabilizer is 5.7 m2, the surface area of the second horizontal stabilizer is 3.9 m2, both have a chord of about 1 m and a vertical separation of 1.8 m. In some embodiments, a vertical separation distance between the first horizontal stabilizer and the second horizontal stabilizer is in the range of 0.25 to 0.75 of the lower horizontal stabilizer span. In some embodiments, a vertical separation distance can be dependent on the required rudder authority and thus elevator size (driven by, e.g., yaw stability, or the need to counteract asymmetric thrust following powerplant failure). In some embodiments, a sweep offset moves the center of pressure further aft from the center of gravity, thus allowing the airfoil of the horizontal stabilizer to have less surface area overall, thus being smaller and lighter. In some embodiments, a dihedral in the bottom surface of the horizontal stabilizer adds stability. In some embodiments, the box tail design itself increases the efficiency due to the elimination of wingtip vortices of a typical tail. In some embodiments, a lower horizontal stabilizer may have approximately 15% thickness-to-chord ratio to support the weight of the upper components, whereas the vertical and upper surfaces may be thinner, such as, for example, 10% thickness-to-chord ratio due to reduced structural load requirement, which enables the upper horizontal stabilizer to be more efficient (lower drag). It should be appreciated that the left and right elevator surfaces 126 can be controlled independently and/or differentially to create a rolling moment, thereby enabling the wing ailerons 120 to be made smaller. The smaller wing ailerons 120 further enable larger flaps 118. It should be appreciated that in some embodiments, using the vertical control surfaces 128a, 128b, 128n can change the pressure distribution across the elevator 126, for example, commanding a left 5-degree deflection in the left vertical control surface may move the mean pressure distribution left/right by a percentage of the elevator width.

The tail flaps 127 may be configured to selectively extend upward above the horizontal stabilizer 124 for changing a surface area, camber, aspect ratio, and/or shape of the horizontal stabilizer 124. The tail flaps 127 may include, for example, one or more of plain flaps, split flaps, slotted flaps, Fowler flaps, slotted or double-slotted Fowler flaps, Gouge flaps, Junkers flaps, or Zap flaps. That is, in some examples, tail flaps 127 serve to change an angle of attack of the horizontal stabilizer 124, change a chord line of the horizontal stabilizer 124, change a surface area of the horizontal stabilizer 124, and/or otherwise increase the net effective downwardly directed lift of the horizontal stabilizer 124. Such configurations effectively reduce the speed at which the horizontal stabilizer 124 becomes aerodynamically effective by creating additional net downward force at low airspeeds to aid in exerting a nose up pitching moment of the WIG 100. The elevators 126 may be configured for changing the aerodynamic shape of the horizontal stabilizer 124 to further control or vary a pitch of the WIG 100.

In operation, tail flaps 127 can be deployed (e.g., extended as depicted in 127a and 127b with dashed lines in FIG. 1G) for takeoff (e.g., transition from hydrofoil-borne mode to airborne mode) and landing (e.g., transition from airborne mode to hull-borne mode) to generate additional downforce on the tail system when additional pitch-up moment is required. Tail flaps 127 can be stowed (e.g., retracted as depicted in FIGS. 1E-1F) for other phases of operation, such as hull-borne mode to reduce downforce on the tail system and reduce drag.

In some examples, the elevators 126 may be additionally configured to extend upward above the horizontal stabilizer 124 in a flaperon-like configuration (yet with elevators, rather than ailerons) to help the tail flaps 127 generate additional downward force on the horizontal stabilizer 124, which may be used to either create a pitching moment or additional balanced downward force. The tail flaps 127 and elevators 126 may each include one or more actuators 125 for raising and lowering the tail flaps 127 and elevators 126, singly or in combination. The actuators 125 can comprise any system configured to selectively actuate the associated system, such as but not limited to a flap track system (integrated into vertical stabilizers 122a, 122b, 122n, which can reduce complex hinge systems or external arms, thereby reducing wetted area and excrescences drag), an electric servo motor mounting within the vertical stabilizers 122a, 122b, 122n and/or horizontal stabilizers 124a, 124b, and/or a central vertical strut system generally mounted in the hull 102 or the fuselage of the WIG 100 (to provide the potential for reduced cross-sectional area and associated drag).

Further, in some examples as depicted in FIG. 1G, the elevators 126 and/or the tail flaps 127 can be positioned so that they are in the wake 129 of one or more of the propeller assemblies 116 of main wing 104. The elevators 126 and/or the tail flaps 127 may be positioned so that they are in the wake 129 of one or more of the propeller assemblies 116 in order to increase the effectiveness of the elevators at low forward velocities. In some examples, the propeller assemblies 116 may be positioned so that no elevators 126 and/or tail flaps 127 are in the wake 129 to ensure consistent and/or predictable aerodynamic forces, independent of power application, are exerted during critical operational phases. In some examples, the propeller assemblies 116 may be positioned so that the elevators 126 are in their wake and the tail flaps 127 are not in the wake 129 (e.g., above the wake 129) and are exposed to clean air 131. It should be understood that positioning of the tail flaps 127 in the second horizontal stabilizer 124b, or at a distance above the center of gravity of the WIG 100, will have the added unexpected benefit of creating additionally nose-up pitching moment as a result of induced drag acting about the center of gravity causing the WIG 100 to pitch upward.

Similar to the flaps 118 and the ailerons 120 of the main wing 104, the elevators 126 may comprise movable hinged surfaces on the trailing or leading edges of the horizontal stabilizer 124 for changing the aerodynamic shape of the horizontal stabilizer 124 to control a pitch of the WIG 100. The horizontal stabilizer 124 may be combined with the elevator 126, creating a fully articulating horizontal stabilizer (e.g., a stabilator). Raising the elevators 126 above the hinge point creates a net downward force on the tail system and causes the WIG 100 to pitch upward. Lowering the elevators 126 below the hinge point creates a net upward force on the horizontal stabilizer 124 and causes the WIG 100 to pitch downward. The elevators 126 may include actuators, which may be operated by a control system of the WIG 100 in order to raise and lower the elevators 126.

In some examples, the tail 106 may include one or more rudders 128a, 128b, 128n. The rudders 128a, 128b, 128n may each comprise a movable hinged surface on the trailing edge of the corresponding vertical stabilizers 122a, 122b, 122n for changing the aerodynamic shape of the vertical stabilizer 122 to control the yaw of the WIG 100 when operating in an airborne mode. It should be understood that rudders 128a, 128b, 128n can operate independently or in combination as desired. Moreover, in some examples, rudders 128a, 128b, 128n can be used as redundant systems, particularly useful in the event of one or more failures.

In some examples, the rudders 128a, 128b, 128n may additionally change a hydrodynamic shape of the hull 102 to control the yaw of the WIG 100 when operating in a waterborne mode. In order to facilitate such hydrodynamic control, the rudders 128a, 128b, 128n may be positioned low enough on the tail 106 that one or more of the rudders 128a, 128b, 128n is partially or entirely submerged when the hull 102 is floating in water. Namely, the rudders 128a, 128b, 128n may be positioned partially or entirely below a waterline of the hull 102. The rudders 128a, 128b, 128n may include one or more actuators, which may be operated by a control system of the WIG 100 in order to rotate the hinged surface of the rudders 128a, 128b, 128n to the left or right of the vertical stabilizer 122. Actuating the rudders 128a, 128b, 128n to the left (relative to the direction of travel) causes the WIG 100 to yaw left. Actuating the rudders 128a, 128b, 128n to the right (relative to the direction of travel) causes the WIG 100 to yaw right. As such, the rudders 128a, 128b, 128n may be used in combination with any of the other mechanisms disclosed herein for controlling the yaw of the WIG 100, including in combination with the ailerons 120 during airborne operation and in combination with varying the rotational speeds of different ones of the propeller assemblies 116 to help improve maneuverability of the WIG 100 during waterborne operation.

As depicted in FIG. 1F, it should be understood that the fundamental shape of tail 106, having one or more vertical stabilizers 122a, 122b, 122n and one or more horizontal stabilizers 124a, 124b, can result in a box-like assembly, wherein the vertical stabilizers are generally coupled to the horizontal stabilizers to form a reinforced box-like construction. This box-like construction provides enhanced structural integrity that enables tail 106 of some examples to be lighter and/or smaller than otherwise constructed.

While not shown in FIGS. 1A-1G, the WIG 100 may also include a distributed propulsion system on the tail 106, which may be similar to the distributed propulsion system of propeller assemblies 116 on the main wing 104. Such a distributed propulsion system may provide similar benefits of increasing the freestream velocity over the control surfaces (e.g., the elevators 126 and/or the rudder 128) to allow for increased pitch and yaw control of the WIG 100 at lower travel speeds. When determining the number and size of propeller assemblies to include on the tail 106, one may apply the same factors described above when determining the number and size of propeller assemblies to include on the main wing 104.

D. Hydrofoil Systems

As further shown in FIGS. 1A-1G, the WIG 100 may include one or more hydrofoil assemblies, such as the main hydrofoil assembly 108, which is positioned closer to the middle or bow of the WIG 100, and the rear hydrofoil assembly 110, which is positioned closer to the stern of the WIG 100. For instance, the main hydrofoil assembly 108 may be positioned between the bow and a midpoint (between the bow and stern) of the WIG 100, and the rear hydrofoil assembly 110 may be positioned below the tail 106 of the WIG 100. The main hydrofoil assembly 108 and the rear hydrofoil assembly 110 may help address a common challenge faced by waterborne WIGs, which is the process of breaking contact between the hull of the WIG and the water surface during takeoff. Prior to becoming airborne, WIGs experience a peak hydrodynamic drag, which is also known as the “hump drag.” This can be problematic for WIGs, as a large amount of power may be required to overcome this hump drag, which is required to further increase forward velocity and transition to airborne flight.

To help address these issues, the main hydrofoil 108 and the rear hydrofoil 110 of the WIG 100 disclosed herein are configured to be retractable, to be large enough to lift the entire WIG out of the water and not impact the water surface, and to enable sustained operation in the hydrofoil-borne mode (where the entire weight of the craft is supported by the hydrofoil). The main hydrofoil assembly 108 may include a main foil 130, one or more main foil struts 132 that couple the main foil 130 to the hull 102, and one or more main foil control surfaces 134. Similarly, the rear hydrofoil assembly 110 may include a rear foil 136, one or more rear foil struts 138 that couple the rear foil 136 to the hull 102, and one or more rear foil control surfaces 140.

The main foil 130 and the rear foil 136 may each take the form of one or more hydrodynamic lifting surfaces (also referred to as “foils”) designed to be operated partially or entirely submerged underwater while the hull 102 of the WIG 100 remains above and clear of the water's surface. In operation, as the WIG 100 moves through water with the main foil 130 and the rear foil 136 submerged, the foils generate a lifting force that causes the hull 102 to rise above the surface of the water. In order to cause the hull 102 to rise above the surface of the water, the lifting force generated by the foils must be at least equal to the weight of the WIG 100. The lifting force of the foils depends on the speed and angle of attack at which the foils move through the water, as well as their various physical dimensions, including the aspect ratio, the surface area, the span, and the chord of the foils.

The height at which the hull 102 is elevated above the surface of the water during hydrofoil-borne operation is limited by the length of the one or more main foil struts 132 that couple the main foil 130 to the hull 102 and the length of the one or more rear foil struts 138 that couple the rear foil 136 to the hull 102. In some examples, the main foil struts 132 and the rear foil struts 138 may be long enough to lift the hull 102 at least five feet above the surface of the water during hydrofoil-borne operation, which may allow for operation in water with larger wave heights (e.g., wave heights up to five feet). However, struts of other lengths may be used as well with the understanding that longer struts will allow for better wave-isolation of the hull 102 (but at the expense of stability of the WIG 100 and increasing complexity of the retraction system).

In practice, hydrofoils have a limited top speed before cavitation occurs, which results in vapor bubbles forming and imploding on the surface of the hydrofoil. Cavitation not only may cause damage to a hydrofoil, but also significantly reduces the amount of lift force generated by the hydrofoil and increases drag. Therefore, it is desirable to reduce the onset of cavitation by designing the main foil 130 and the rear foil 136 in a way that allows the foils to operate at higher speeds (e.g., ˜20-45 mph) and across the entire required hydrofoil-borne speed envelope before cavitation occurs. For instance, the onset of cavitation may be controlled based on the geometric design of the main foil 130 and the rear foil 136. Additionally, the structural design of the main foil 130 and the rear foil 136 may allow the surfaces of the foils to flex and twist at higher speeds, which may reduce loading on the foils and delay the onset of cavitation.

Further, the distributed blown-wing propulsion system described above may help further delay the onset of cavitation on the main foil 130 and the rear foil 136. Cavitation on a hydrofoil is caused by both (i) the profile of the hydrofoil (which is affected by both the hydrofoil's angle of attack and its vertical thickness) and (ii) the amount of lift force generated by the hydrofoil as it moves through water. Therefore, reducing the amount of lift force generated by the hydrofoil can help delay the onset of cavitation. One way to reduce the amount of lift force generated by the hydrofoil is to share the load (i.e., the weight) of the vehicle across both the hydrofoil and the aerodynamic main wing 104. As described above, the blown-wing propulsion system creates additional lift on the main wing 104, thereby causing the main wing 104 to bear more of the vehicle's weight and reducing the amount of lift force exerted on the main foil 130 and the rear foil 136 to lift the hull 102 out of the water. Further, because the main foil 130 and the rear foil 136 do not need to generate as much lift force to raise or sustain the hull 102 out of the water, their angles of attack may be reduced as well, which further delays the onset of cavitation. By combining the blown-wing propulsion system with the hydrofoil designs described herein, the WIG 100 may operate in a hydrofoil-borne mode at speeds above 35 knots before cavitation occurs.

The main foil 130 and/or the rear foil 136 may take any of various forms. As shown in FIGS. 1A-1F, the main foil 130 and the rear foil 136 may be substantially flat along a horizontal plane, such that the foils are configured to be fully submerged during operation. However, in other examples, the main foil 130 and/or the rear foil 136 may include one or more angled surfaces, such that the foil is a surface-piercing foil configured to be partially submerged during operation. For instance, as shown in FIG. 1G, the main foil 130 may have a flattened V-shaped design in which a center portion of the main foil 130 is substantially flat and the ends of the main foil 130 extend upward toward the hull 102 of the WIG 100. This flattened V-shape design may allow for passive regulation of the distance between the hull 102 and the surface of the water (also referred to as “ride height”) while also allowing for passive roll-moment control. The passive regulation of ride height is achieved by having the tips of the V-shaped hydrofoil breach the surface of the water, reducing the extent of the lifting surface that is underwater. If the ride height is too low, the increased hydrofoil surface area under the surface of the water will create a net force greater than the weight of the WIG 100, causing it to rise higher. If the ride height is too high, more of the hydrofoil's lifting surface will be above the water surface and there will not be enough hydrofoil lifting area under the surface of the water, causing the WIG 100 to descend closer to the water until equilibrium is achieved. The passive roll stability is due to one side of the V-shaped hydrofoil breaching further out of the water than the other side. This creates a stabilizing roll moment when the WIG 100 is rolled to (for example) the left, because the left side of the V-shaped hydrofoil will have more surface under the water surface, allowing it to generate more lift than the right side.

As noted above, the main hydrofoil assembly 108 may include one or more main foil control surfaces 134, and the rear hydrofoil assembly 110 may include one or more rear foil control surfaces 140. The main foil control surfaces 134 may include one or more hinged surfaces on a trailing or leading edge of the main foil 130 as well as one or more actuators, which may be operated by a control system of the WIG 100 in order to rotate the hinged surfaces so that they extend above or below the main foil 130. The main foil control surfaces 134 on the main foil 130 may be operated in a similar manner as the flaps 118 and ailerons 120 on the wing 104 of the WIG 100. As one example, lowering the control surfaces 134 to extend below the main foil 130 may change a hydrodynamic shape of the main foil 130 in a manner that generates additional lift on the main foil 130, similar to the aerodynamic effect of lowering the flaps 118. As another example, asymmetrically raising one or more of the control surfaces 134 (e.g., raising a control surface 134 on only one side of the main foil 130) may change a hydrodynamic shape of the main foil 130 in a manner that generates a roll force on the main foil 130, similar to the aerodynamic effect of raising one of the ailerons 120.

Likewise, the rear foil control surfaces 140 may include one or more hinged surfaces on a trailing or leading edge of the rear foil 136 as well as one or more actuators, which may be operated by a control system of the WIG 100 in order to rotate the hinged surfaces so that they extend above or below the rear foil 136. The rear foil control surfaces 140 on the rear foil 136 may be operated in a similar manner as the elevators 126 on the tail 106 of the WIG 100. As one example, lowering the control surfaces 140 to extend below the rear foil 136 may change a hydrodynamic shape of the rear foil 136 in a manner that causes the WIG 100 to pitch downwards, similar to the aerodynamic effect of lowering the elevators 126. As another example, raising the control surfaces 140 to extend above the rear foil 136 may change a hydrodynamic shape of the rear foil 136 in a manner that causes the WIG 100 to pitch upwards, similar to the aerodynamic effect of raising the elevators 126.

In some examples, one or both of the main foil control surfaces 134 or the rear foil control surfaces 140 may include rudder-like control surfaces similar to the rudder 128 on that tail 106 of the WIG 100. For instance, the main foil control surfaces 134 may include one or more hinged surfaces on a trailing edge of the main foil strut 132 as well as one or more actuators, which may be operated by a control system of the WIG 100 in order to rotate the hinged surfaces so that they extend to the left or right of the main foil strut 132. Similarly, the rear foil control surfaces 140 may include one or more hinged surfaces on a trailing edge of the rear foil strut 138 as well as one or more actuators, which may be operated by a control system of the WIG 100 in order to rotate the hinged surfaces so that they extend to the left or right of the rear foil strut 138. Actuating the main foil control surfaces 134 or the rear foil control surfaces 140 in this manner may respectively change a hydrodynamic shape of the main foil strut 132 or the rear foil strut 138, which may allow for controlling the yaw of the WIG 100 when operating in a waterborne or hydrofoil-borne mode, similar to the effect of actuating the rudder 128 of the WIG 100 as described above.

In some examples, instead of (or in addition to) actuating hinged control surfaces on the main foil 130 and/or the rear foil 136, a control system of the WIG 100 may actuate the entire main foil 130 and/or the entire rear foil 136 themselves. As one example, the WIG 100 may include one or more actuators for rotating the main foil 130 and/or the rear foil 136 around the yaw axis. As another example, the WIG 100 may include one or more actuators for controlling an angle of attack of the main foil 130 and/or the rear foil 136 (i.e., rotating the main foil 130 and/or the rear foil 136 around the pitch axis). As another example, the WIG 100 may include one or more actuators for rotating the main foil 130 and/or the rear foil 136 around the roll axis. As another example, the WIG 100 may include one or more actuators for changing a camber or shape of the main foil 130 and/or the rear foil 136. As yet another example, the WIG 100 may include one or more actuators for flapping the main foil 130 and/or the rear foil 136 to help propel the WIG 100 forward or backwards. Other examples are possible as well.

Further, in some examples, the WIG 100 may dynamically control an extent to which the main foil 130 and/or the rear foil 136 are deployed based on an operational mode (e.g., hull-borne, hydrofoil-borne, or wing-borne modes) of the WIG 100. For instance, during hull-borne mode, the rear foil 110 may be partially deployed or retracted to increase turning authority. The amount of partial deployment or retraction may be a function of the desired overall vehicle draft when operating in a shallow water environment. During hydrofoil-borne mode, the main hydrofoil 108 may be partially retracted in order to reduce the distance between the hull of the vehicle and the water's surface. This may increase the amount of lift generated by the main wing 104 by operating the wing closer to the surface of the water, increasing the effects of aerodynamic ground effect.

As noted above, one or both of the main hydrofoil assembly 108 or the rear hydrofoil assembly 110 may interface with a deployment system that allows for retracting the main hydrofoil assembly 108 and/or the rear hydrofoil assembly 110 into or toward the hull 102 for hull-borne or wing-borne operation and extending the main hydrofoil assembly 108 and/or the rear hydrofoil assembly 110 below the hull 102 for hydrofoil-borne operation.

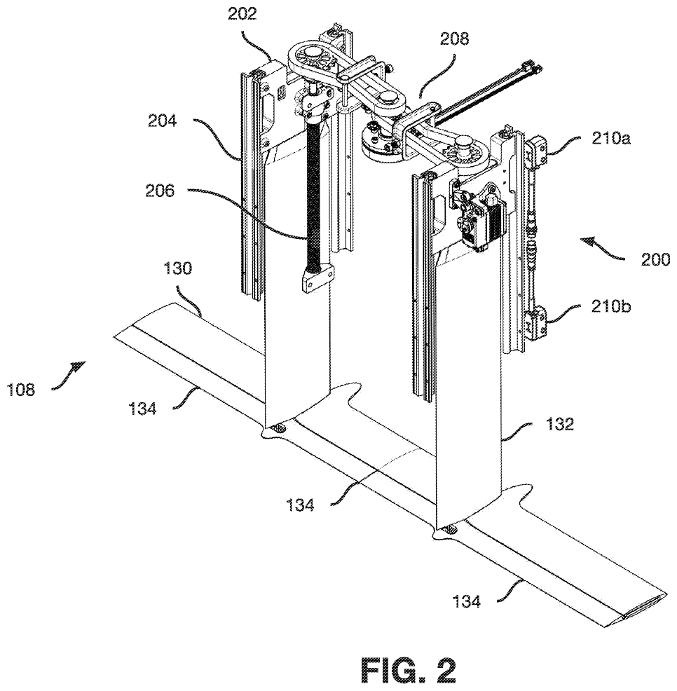

FIG. 2 depicts an example main hydrofoil deployment system 200 that allows for retracting and extending the main hydrofoil assembly 108. As shown, the main hydrofoil deployment system 200 may take the form of a linear actuator that includes one or more brackets 202 coupling the main hydrofoil assembly 108 (by way of the main foil struts 132) to one or more vertical tracks 204. The brackets 202 may be configured to move vertically along the tracks 204, such that when the brackets 202 move vertically along the tracks 204, the main hydrofoil assembly 108 likewise moves vertically. The brackets 202 may be coupled to a leadscrew 206 that, when rotated, causes vertical movement of the brackets 202. The leadscrew 206 may be rotated by any of various sources of torque, such as an electric motor coupled to the leadscrew 206 by a gearbox 208.

The main hydrofoil deployment system 200 may further include one or more sensors 210 configured to detect a vertical position of the main hydrofoil assembly 108. As shown, the sensors 210 include a first sensor 210a that senses when the main hydrofoil assembly 108 has reached a fully retracted position and a second sensor 210b that senses when the main hydrofoil assembly 108 has reached a fully extended position. However, the main hydrofoil deployment system 200 may include additional sensors for detecting additional discrete positions or continuous positions of the main hydrofoil assembly 108. The sensors 210 may be included as part of, or otherwise configured to communicate with, the control system of the WIG 100 to provide the control system with data indicating the position of the main hydrofoil assembly 108. The control system may then use the data from the sensors 210 to determine whether to operate the electric motor to retract or extend the main hydrofoil assembly 108.

In some examples, such as examples where the linear actuator is not a self-locking linear actuator, the main foil deployment system 200 may include a locking or braking mechanism for holding the main foil struts 132 in a fixed position (e.g., in a fully retracted or fully extended position). The locking mechanism may be, for example, a dual-action mechanical brake coupled to the electric motor, the leadscrew 206, or the gearbox 208.

While the above description provides various details of an example main foil deployment system 200, it should be understood that the main foil deployment system 200 depicted in FIG. 2 is for illustrative purposes and is not meant to be limiting. For instance, the main foil deployment system 200 may include any of various linear actuators now known or later developed that are capable of retracting and extending the main hydrofoil assembly 108.

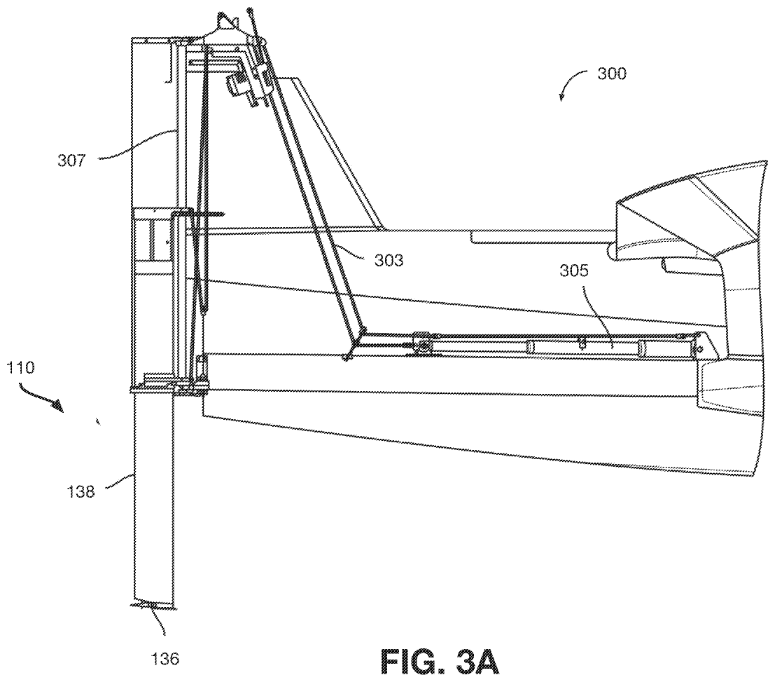

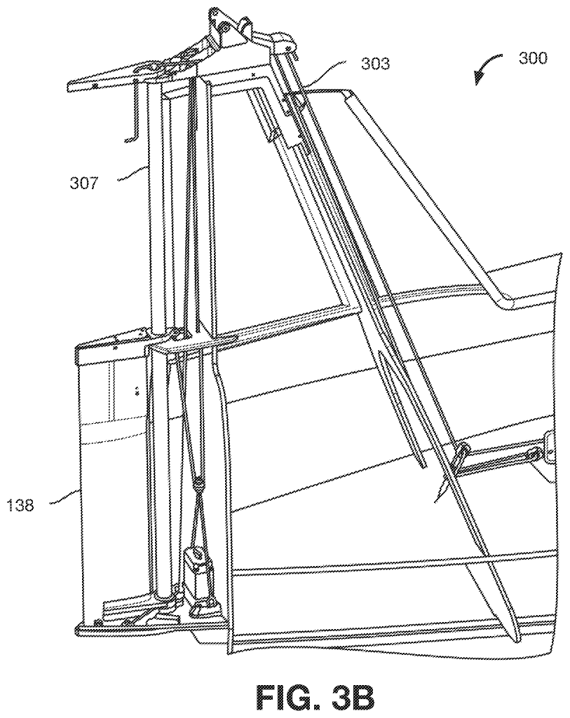

FIGS. 3A and 3B depict an example rear foil deployment system 300 that allows for retracting and extending the rear foil 136. As shown, the rear foil deployment system 300 may include a pulley system 303 that couples an actuator 305 to the rear foil strut 138. When actuated, the actuator 305 causes the pulley system 303 to raise or lower the rear foil strut 138 by causing the rear foil strut 138 to slide vertically along a shaft 307. While not depicted in FIGS. 3A and 3B, the rudder 128 may also be mounted to the shaft 307 such that, when the actuator 305 raises the rear foil strut 138, the rear foil strut 138 retracts at least partially into the rudder 128. Additionally, the rear foil deployment system 300 may include one or more servo motors for rotating the rear foil strut 138 around the shaft. In this respect, the rear foil strut 138 may be rotated around the shaft to act as a hydro-rudder when submerged in water or to act as an aero-rudder when out of the water. Further, because the rudder 128 is mounted to the same shaft 307 as the rear foil strut 138 and the rear foil strut 138 can be retracted into the rudder 128, the same servo motor can also be used to control rotation of the rudder 128.

The actuator 305 of the rear foil deployment system 300 may take various forms and may, for instance, include any of various linear actuators now known or later developed that are capable of retracting and extending the rear hydrofoil assembly 110. Further, in some examples, the actuator 305 may have a non-unitary actuation ratio such that a given movement of the actuator 305 causes a larger corresponding induced movement of the rear hydrofoil assembly 110. This can help allow for faster retractions of the rear hydrofoil assembly 110, which may be beneficial during takeoff, as described in further detail below.

The main hydrofoil assembly 108 and/or the rear hydrofoil assembly 110 may be designed such that, when fully retracted, the hydrofoil assembly is flush, conformal, or tangent to the hull 102. For instance, in some examples, the hull 102 may include one or more recesses configured to receive the main hydrofoil assembly 108 and/or the rear hydrofoil assembly 110, and the main hydrofoil assembly 108 and/or the rear hydrofoil assembly 110 may be shaped such that when the main hydrofoil assembly 108 and/or the rear hydrofoil assembly 110 are fully retracted into the one or more recesses of the hull 102, the outer contour of the hull 102 forms a substantially smooth transition at the intersection of the hull 102 and the main hydrofoil assembly 108 and/or the rear hydrofoil assembly 110.

In other examples, the main hydrofoil assembly 108 and/or the rear hydrofoil assembly 110 may not conform to the shape of the hull 102 when fully retracted but instead may protrude slightly below the hull 102. In these examples, the main hydrofoil assembly 108 and/or the rear hydrofoil assembly 110 may have a non-negligible effect on the aerodynamics of the WIG 100, and the WIG 100 may be configured to leverage these effects to provide additional control of the WIG 100. For instance, when the main hydrofoil assembly 108 and/or the rear hydrofoil assembly 110 are retracted but still exposed, the exposed hydrofoil may be manipulated in flight to impart forces and moments on the WIG 100 similar to an aero-control surface. Traditional hydrofoils have control surfaces (such as flaps attached at the rear) that are sized to displace water and would not be effective in much-lighter-than-water air. One or both of the main hydrofoil assembly 108 and/or the rear hydrofoil assembly 110 of the WIG 100 disclosed herein, however, may be mounted on a pivot which is locked underwater but may be unlocked to allow the hydrofoil to move around the pivot in the air. At that point, the control surfaces act like trim tabs and are able to effect movement of the entire unlocked, pivoting hydrofoil which would otherwise impractically large and heavy servo motors. An additional benefit of this design is that the hydrofoil may be unlocked and moved through a slow servo and/or a combination of control surface movement combined with forward movement through water, and then re-locked such that the hydrofoil is at a selected angle of incidence.

Because the main hydrofoil assembly 108 is configured to be retractable, the hull 102 may include openings through which the struts 132 of the main hydrofoil assembly 108 may be retracted and extended. However, when the hull 102 contacts the water surface, water may seep into the hull 102 through these openings. To account for this, the hull 102 may be designed to isolate any water that enters the hull 102 and allow for the water to drain from the hull 102 when the hull 102 is lifted out of the water. For instance, the hull 102 may include pockets 142 on each side of the hull 102 aligned above the struts 132. The pockets 142 may be isolated from the remainder of the interior of the hull 102 so that when water accumulates in the pockets 142, the water does not reach any undesired areas, like the cockpit, passenger seating area, or any areas that house the battery system or components of the control system of the WIG 100. Further, the pockets 142 may include venting holes or other openings located at or near the bottom of the pockets 142. While such venting openings may allow water to enter the pockets 142, they may likewise allow any accumulated water to vent out of the pockets 142 when the hull 102 is lifted out of the water.

While not shown in the figures, the main hydrofoil assembly 108 and/or the rear hydrofoil assembly 110 may further include one or more propellers for additional propulsion when submerged underwater. For instance, one or more propellers may be mounted to the main foil 130 and/or the rear foil 136. Such propellers may provide additional propulsion force to the WIG 100 during hydrofoil-borne or hull-borne operation. In some examples, the one or more propellers may additionally or alternatively be mounted to the hull 102 such that the propellers are submerged during hull-borne operation and may be used to provide additional propulsion force to the WIG 100 during hull-borne operation.

The main hydrofoil assembly 108 and/or the rear hydrofoil assembly 110 may further include various failsafe mechanisms in case of malfunction. For instance, if the main hydrofoil deployment system 200 or the rear hydrofoil deployment system 300 malfunctions and cannot retract the main hydrofoil assembly 108 and/or the rear hydrofoil assembly 110, then the WIG 100 may be configured to jettison the assembly that is unable to be retracted. The main hydrofoil assembly 108 and/or the rear hydrofoil assembly 110 may be coupled to the hull 102 by a releasable latch. The control system of the WIG 100 may identify a retraction malfunction, for instance based on data received from the positional sensors 210, and the control system may responsively open the latch to release the connection between the hull 102 and the malfunctioning hydrofoil assembly. In some examples, the weight of the malfunctioning hydrofoil assembly may provide sufficient force to jettison the malfunctioning hydrofoil assembly out of the hull 102 when the latch is opened, or the WIG 100 may include an actuator or some other mechanism to jettison the malfunctioning hydrofoil assembly out of the hull 102. In other examples, instead of jettisoning a malfunctioning hydrofoil assembly, the main hydrofoil assembly 108 and/or the rear hydrofoil assembly 110 may be designed to break in a controlled manner upon impact with a water surface. For instance, a joint between the main foil struts 132 and the hull 102 and/or a joint between the rear foil struts 138 and the hull 102 may be configured to disconnect when subjected to a torque significantly larger than standard operational torques at the joints. Other designs for providing controlled breaks are possible as well.

E. Control System

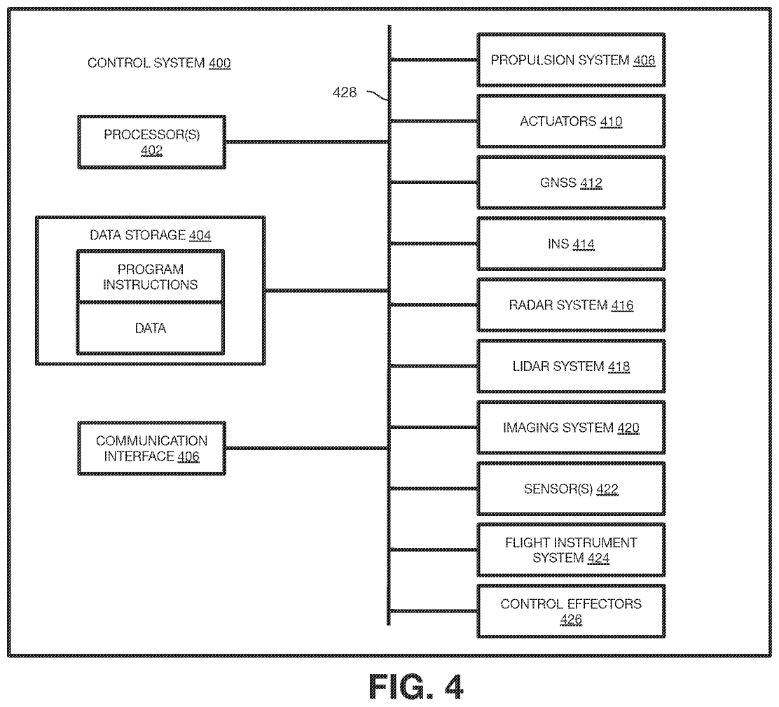

FIG. 4 depicts a simplified block diagram illustrating various components that may be included in an example control system 400 of the WIG 100. The components of the control system 400 may include one or more processors 402, data storage 404, a communication interface 406, a propulsion system 408, actuators 410, a Global Navigation Satellite System (GNSS) 412, an inertial navigation system (INS) 414, a radar system 416, a lidar system 418, an imaging system 420, various sensors 422, a flight instrument system 424, and control effectors 426, some or all of which may be communicatively linked by one or more communication links 428 that may take the form of a system bus, a communication network such as a public, private, or hybrid cloud, or some other connection mechanism.

The one or more processors 402 may comprise one or more processing components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. Further, while the one or more processors 402 are depicted as a separate stand-alone component of the control system 400, it should also be understood that the one or more processors 402 could comprise processing components that are distributed across one or more of the other components of the control system 400.

The data storage 404 may comprise one or more non-transitory computer-readable storage mediums that are collectively configured to store (i) program instructions that are executable by the one or more processors 402 such that the control system 400 is configured to perform some or all of the functions disclosed herein, and (ii) data that may be received, derived, or otherwise stored, for example, in one or more databases, file systems, or the like, by the control system 400 in connection with the functions disclosed herein. In this respect, the one or more non-transitory computer-readable storage mediums of data storage 404 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. Further, while the data storage 404 is depicted as a separate stand-alone component of the control system 400, it should also be understood that the data storage 404 may comprise computer-readable storage mediums that are distributed across one or more of the other components of the control system 400.

The communication interface 406 may include one or more wireless interfaces and/or one or more wireline interfaces, which allow the control system 400 to communicate via one or more networks. Example wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Example wireline interfaces may include an Ethernet interface, a Universal Serial Bus (USB) interface, CAN Bus, RS-485, or similar interface to communicate via a wire, a twisted pair of wires, a coaxial cable, an optical link, a fiber-optic link, or other physical connection to a wireline network.

The propulsion system 408 may include one or more electronic speed controllers (ESCs) for controlling the electric motor propeller assemblies 116 distributed across the main wing 104 and, in some examples, across the horizontal stabilizer 124. In some examples, the propulsion system 408 may include a separate ESC for each respective propeller assembly 116, such that the control system 400 may individually control the rotational speeds of the electric motor propeller assemblies 116.

The actuators 410 may include any of the actuators described herein, including (i) actuators for raising and lowering the flaps 118, ailerons 120, elevators 126, main foil control surfaces 134, and rear foil control surfaces 140, (ii) actuators for turning the rudder 128, the main foil control surfaces 134 positioned on the main foil struts 132, and the rear foil control surfaces 140 positioned on the rear foil strut 138, (iii) actuators for retracting and extending the main hydrofoil assembly 108 and the rear hydrofoil assembly 110, and/or (iv) actuators for performing the various other disclosed actuations of the main hydrofoil assembly 108 and the rear hydrofoil assembly 110. Each of the actuators described herein may include any actuators now known or later developed capable of performing the disclosed actuation. Examples of different types of actuators may include linear actuators, rotary actuators, hydraulic actuators, pneumatic actuators, electric actuators, electro-hydraulic actuators, and mechanical actuators. Further, more specific examples of actuators may include electric motors, stepper motors, and hydraulic cylinders. Other examples are contemplated herein as well.

The GNSS system 412 may be configured to provide measurement of the location, speed, altitude, and heading of the WIG 100. The GNSS system 412 includes one or more radio antennas paired with signal processing equipment. Data from the GNSS system 412 may allow the control system 400 to estimate the position and velocity of the WIG 100 in a global reference frame, which can be used for route planning, operational envelope protection, and vehicle traffic deconfliction by both understanding where the WIG 100 is located and comparing the location with known traffic.

The INS 414 may include various sensors that are configured to provide data that is typical of well-known INS systems. For example, the INS 414 may include motion sensors, such as angular and/or linear accelerometers, and rotational sensors, such as gyroscopes, to calculate the position, orientation, and velocity of the WIG 100 using dead reckoning techniques. One or more INS systems may be used by the control system to calculate actuator outputs to stabilize or otherwise control the vehicle during all modes of operation.

The radar system 416 may be configured to provide data that is typical of well-known radar systems. For example, the radar system 416 may include a transmitter and a receiver. The transmitter may transmit radio waves via a transmitting antenna. The radio waves reflect off an object and return to the receiver. The receiver receives the reflected radio waves via a receiving antenna, which may be the same antenna as the transmitting antenna, and the radar system 416 processes the received radio waves to determine information about the object's location and speed relative to the WIG 100. This radar system 416 may be utilized to detect, for example, the water surface, maritime or airborne vehicle traffic, wildlife, or weather.

The lidar system 418 may be configured to provide data that is typical of well-known lidar systems. For example, the lidar system 418 may include a light source and an optical receiver. The light source emits a laser that reflects off an object and returns to the optical receiver. The lidar system 418 measures the time for the reflected light to return to the receiver to determine a distance between the WIG 100 and the object. This lidar system 418 may be utilized by the flight control system to measure the distance from the WIG 100 to the surface of the water in various spatial measurements.

The imaging system 420 may include one or more still and/or video cameras configured to capture image data from the environment of the WIG 100. In some examples, the cameras may include charge-coupled device (CCD) cameras, complementary metal-oxide-semiconductor (CMOS) cameras, short-wave infrared (SWIR) cameras, mid-wave infrared (MWIR) cameras, or long-wave infrared (LWIR) cameras. The imaging system 420 may provide any of various possible applications, such as obstacle avoidance, localization techniques, water surface tracking for more accurate navigation (e.g., by applying optical flow techniques to images), video feedback, and/or image recognition and processing, among other possibilities.

As noted above, the control system 400 may further include various other sensors 422 for use in controlling the WIG 100. In line with the discussion above, examples of such sensors 422 may include thermal sensors or other fire detection sensors for detecting a fire in the hull 102 or for detecting thermal runaway in the battery system. As further described above, the sensors 422 may include position sensors for sensing a position of the main hydrofoil assembly 108 and/or the rear hydrofoil assembly 110 (e.g., sensing whether the assemblies are in a retracted or extended position). Examples of position sensors may include photodiode sensors, capacitive displacement sensors, eddy-current sensors, Hall effect sensors, inductive sensors, or any other position sensors now known or later developed.

In some examples, the sensors 422 may include any of various altimeter sensors. As one example, the sensors 422 may include an ultrasonic altimeter configured to emit and receive ultrasonic waves. The emitted ultrasonic waves reflect off the water surface below the WIG 100 and return to the altimeter. The ultrasonic altimeter measures the time for the reflected ultrasonic wave to return to the altimeter to determine a distance between the WIG 100 and the water surface. As another example, the sensors 422 may include a barometer for use as a pressure altimeter. The barometer measures the atmospheric pressure in the environment of the WIG 100 and determines the altitude of the WIG 100 based on the measured pressure. As another example, the sensors 422 may include a radar altimeter to emit and receive radio waves. The radar altimeter measures the time for the radio wave to reflect off of the surface of the water below the WIG 100 to determine a distance between the WIG 100 and the water surface. These various sensors may be placed on different locations on the WIG 100 in order to reduce the impact of sensor constraints, such as sensor deadband or sensitivity to splashing water.

Further, the control system 400 may be configured to use various ones of the sensors 422 or other components of the control system 400 to help navigate the WIG 100 through maritime traffic or to avoid any other type of obstacle. For example, the control system 400 may determine a position, orientation, and velocity of the WIG 100 based on data from the INS 414 and/or the GNSS 412, and the control system 400 may determine the location of an obstacle, such as a maritime vessel, a dock, or various other obstacles, based on data from the radar system 416, the lidar system 418, and/or the imaging system 420. In some examples, the control system 400 may determine the location of an obstacle using the Automatic Identification System (AIS). In any case, based on the determined position, orientation, and velocity of the WIG 100 and the determined location of the obstacle, the control system 400 may maneuver the WIG 100 to avoid collision with the obstacle by actuating various control surfaces of the WIG 100 in any of the manners described herein.

The flight instrument system 424 may include various instruments for providing a pilot of the WIG 100 with data about the flight situation of the WIG 100. Example instruments may include instruments for providing data about the altitude, velocity, heading, orientation (e.g., yaw, pitch, and roll), battery levels, or any other information provided by the various other components of the control system 400.

The control effectors 426 may include various input devices that may allow an operator to interact with and input signals to the control system 400. Example control effectors 426 may include one or more joysticks, thrust control levers, buttons, switches, dials, levers, or touch screen displays, to name a few. In operation, a pilot may use the control effectors 426 to operate one or more control surfaces of the WIG 100. For instance, as one example, when the pilot moves the joystick in a particular direction, the control system 400 may actuate one or more control surfaces of the WIG 100 to cause the WIG 100 to move in the direction corresponding to the joystick movement. As another example, when the pilot actuates (or increases actuation of) the throttle, the control system 400 may cause a propulsion control surface of the WIG 100 (e.g., the propeller assemblies 116) to increase the propulsion force exerted on the WIG 100, and when the pilot reduces actuation of the throttle, the control system 400 may cause a propulsion control surface of the WIG 100 to decrease the propulsion force exerted on the WIG 100. Other examples of control effectors 426 may be implemented for actuating various control surfaces of the WIG 100 as well.

The control surfaces on the WIG 100 may be utilized by the control system 400 in different modes of operation. The amount of deflection of each control surface may be calculated by the control system 400 based on a number of input variables, including but not limited to vehicle position, velocity, attitude, acceleration, rotational rates, and/or altitude above water. Table 1 below identifies, for each control surface of the WIG 100, example operational modes in which the control surface may be used to control movement of the WIG 100. In the tables below, the propulsion control surfaces may include the propeller assembly 116 as well as any propellers mounted to the hull 102, main hydrofoil assembly 108, or rear hydrofoil assembly 110. The aerodynamic elevator control surfaces may include elevator 126, the aerodynamic ailerons may include ailerons 120, the aerodynamic rudder may include rudder 128 (when not submerged), the aerodynamic flaps may include flaps 118, the hydrodynamic elevator may include rear foil control surfaces 140, the hydrodynamic flaps may include main foil control surfaces 134, and the hydrodynamic rudder may include rudder 128 (when submerged).

TABLE 1
Example operational modes (Hull-borne, Hydrofoil-borne,
Wing-borne) supported by control surfaces of the WIG 100.

| Control Surface | Hull-borne | Hydrofoil-borne | Wing-borne |
|---|---|---|---|
| Propulsion | Y | Y | Y |
| Aerodynamic Elevator | N | Y | Y |
| Aerodynamic Ailerons | N | Y | Y |
| Aerodynamic Rudder | Y | Y | Y |
| Aerodynamic Flaps | N | Y | Y |
| Hydrodynamic Elevator | Y | Y | N |
| Hydrodynamic Flaps | Y | Y | N |
| Hydrodynamic Rudder | Y | Y | N |

When actuating the control surfaces in the various example operational modes identified in Table 1 above, the control system 400 may execute different levels of stabilization along the various vehicle axes during different modes of operation. Table 2 below identifies example stabilization controls that the control system 400 may apply during the various modes of operation for each axis of the WIG 100. Closed loop control may comprise feedback and/or feed forward control.

TABLE 2
Example stabilization control techniques applied to different
axes of the WIG 100 for each operational mode.

| Vehicle Axis | Hull-borne | Hydrofoil-borne | Wing-borne |
|---|---|---|---|
| Pitch Axis | None | Closed loop control | Closed loop control |
| | | on vehicle ride height | on vehicle altitude |
| Roll Axis | None | Closed loop control | Stabilization and |
| | | around vehicle bank | closed loop control |
| | | angle = 0 | on heading |
| Yaw Axis | Rate stabilization | Closed loop control | Closed loop control |
| | | on vehicle heading | on vehicle heading |
| Speed Control | Closed loop control | Closed loop control | Closed loop control |
| | on vehicle GPS Speed | on vehicle GPS Speed | on vehicle airspeed |

Further, the control system 400 may be configured to actuate different control surfaces to control movement of the WIG 100 about its different axes. Table 3 below identifies example axial motions that are affected by the various control surfaces of the WIG 100.

TABLE 3
Example axial motions affected by various
control surfaces of the WIG 100.

| Control Surface | Axis Control Function | |
|---|---|---|
| Propulsion | (a) | accelerate and decelerate the vehicle |
| | (b) | turn the vehicle about yaw axis |
| | (c) | create a rolling moment |
| Aerodynamic Elevator | (a) | create a pitch up or pitch down moment |
| Aerodynamic Ailerons | (a) | create a rolling moment |
| | (b) | increase lift on aerodynamic wing |
| | (c) | create a pitch down moment |
| Aerodynamic Rudder | (a) | create a yawing moment |
| Aerodynamic Flaps | (a) | increase lift on aerodynamic wing |
| | (b) | create a pitch down moment |
| Hydrodynamic Elevator | (a) | create a pitch moment |
| | (b) | generate heave force on rear hydrofoil |
| Hydrodynamic Flaps | (a) | generate heave force on main hydrofoil |
| Hydrodynamic Rudder | (a) | create a yaw moment |

### III. Example Modes of Operation

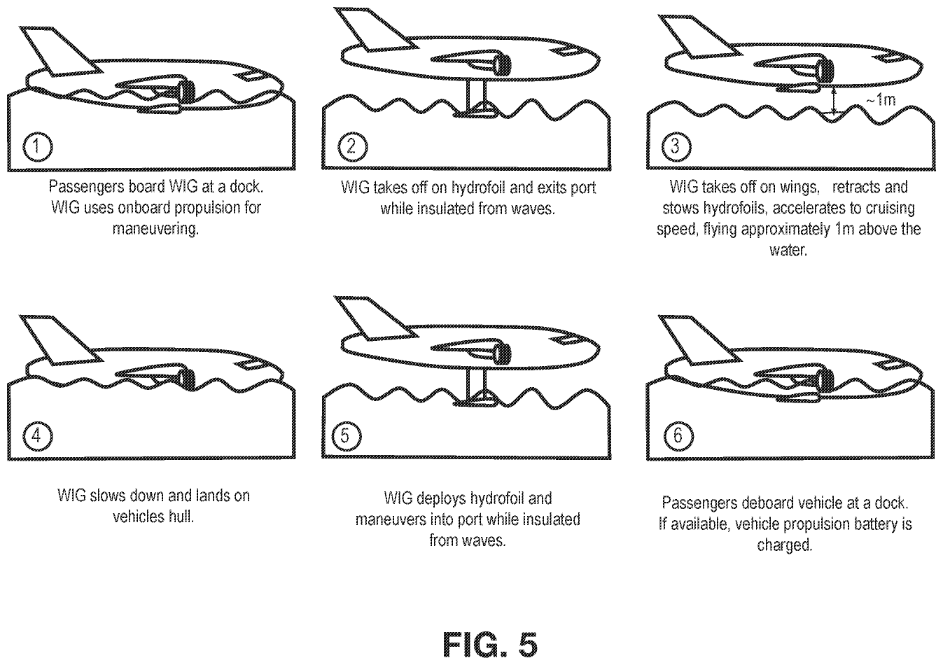

FIG. 5 depicts various example modes of operation of the WIG 100, separated into six numbered stages, each of which are described in further detail below.

A. Hull-Borne Operation

At stage one, the WIG 100 is docked and floating on the hull 102 (i.e., in a hull-borne mode) with the buoyancy of the outriggers 114 providing for roll stabilization of the WIG 100. While docked, the battery system of the WIG 100 may be charged. Rapid charging may be aided with water-based cooling systems, which may be open- or closed-loop systems. The surrounding body of water may be used in the loop or as a heat sink. In some examples, the WIG 100 may include a heat sink integrated into the hull 102 for exchanging heat from the battery system to the surrounding body of water. In other examples, the heat sink may be located offboard in order to reduce the mass of the WIG 100.

Additionally, while the WIG 100 is docked, the propeller assemblies 116 may be folded in a direction away from the dock to help avoid collision with nearby structures or people. This folding may be actuated in various ways, such as by metal spring force, hydraulic pressure, electromechanical actuation, or centrifugal force due to propeller rotation. Other examples are possible as well. Further, the main hydrofoil assembly 108 and the rear hydrofoil assembly 110 may be retracted (or partially retracted) to avoid collisions with nearby underwater structures.

Once any passengers or cargo have been loaded onto the WIG 100 and the WIG 100 is ready to depart, the WIG 100 can use its propulsion systems, including the propeller assemblies 116 and/or the underwater propulsion system (e.g., one or more propellers mounted to the hull 102, the main foil 130, and/or the rear foil 136), to maneuver away from the dock while remaining hull-borne. In some examples, the main hydrofoil assembly 108 and the rear hydrofoil assembly 110 may remain retracted (or partially retracted) during this maneuvering to reduce the risk of hitting underwater obstacles near docks or in shallow waterways. However, when there is limited risk of hitting underwater obstacles, the WIG 100 may partially or fully extend the main hydrofoil assembly 108 and/or the rear hydrofoil assembly 110. With the main hydrofoil assembly 108 and/or the rear hydrofoil assembly 110 extended, the WIG 100 may actuate the main foil control surfaces 134 and/or the rear foil control surfaces 140 to improve maneuverability as described above.

At low speeds during hull-borne operation, the control system 400 may control a position and/or rotation of the WIG 100 by causing all of the propeller assemblies 116 to spin at the same idle speed, but with a first subset spinning in a forward direction and a second subset spinning in a reverse direction. For example, the control system 400 may cause propeller assemblies 116a, 116c, 116f, and 116h to idle in reverse and propeller assemblies 116b, 116d, 116e, and 116g to idle forward. In this arrangement, the control system 400 may cause the WIG 100 to make various maneuvers without having to change the direction of rotation of any of the propeller assemblies 116. For instance, in order to induce a yaw on the WIG 100, the control system 400 may increase the speed of the reverse propeller assemblies on one side of the wing 104 while increasing the speed of the forward propeller assemblies on the other side of the wing 104 and without causing any of the propeller assemblies to transition from forward to reverse or from reverse to forward. For example, idling the propellers at a nominal RPM may allow for faster response in generating a yaw moment on the WIG 100, because the propellers required for generating the yaw moment do not have to increase from zero RPM to the desired RPM value, they can spin from the idle RPM to the desired RPM value.

B. Hydrofoil-Borne Operation

In order to transition to stage two, the WIG 100 can fully extend the main hydrofoil assembly 108 and the rear hydrofoil assembly 110 (if not already extended) and accelerate using the propulsion system as previously described. The WIG 100 accelerates to a speed at which the main hydrofoil assembly 108 and the rear hydrofoil assembly 110 alone support the weight of the WIG 100, and the hull 102 is lifted above the surface of the water and clear of any surface waves (e.g., example embodiments may support a maximum wave height of ˜3-5 ft).

While transitioning to this hydrofoil-borne mode, the control system 400 may actuate the main foil control surfaces 134 and/or the rear foil control surfaces 140 and/or the propulsion system to stabilize the attitude of the WIG 100 in order to maintain the desired height above the surface of the water, vehicle heading, and vehicle forward velocity. For instance, the control system 400 may detect various changes in the yaw, pitch, or roll of the WIG 100 based on data provided by the INS 414, and the control system 400 may make calculated actuations of the main foil control surfaces 134 and/or the rear foil control surfaces 140 to counteract the detected changes.

Once the WIG 100 has fully transitioned to hydrofoil-borne operation and the hull 102 leaves the surface of the water, the drag forces exerted on the WIG 100 drop significantly due to the hull 102 no longer contributing to the water-based drag. As such, the control system 400 may reduce the speeds of the propeller assemblies 116 to lower the thrust of the WIG 100. The control system 400 can sustain this operational mode by actively controlling the pitch and speed of the WIG 100 so that the main hydrofoil assembly 108 and the rear hydrofoil assembly 110 continue to entirely support the weight of the WIG 100.

C. Wing-Borne Operation

In order to transition to wing-borne operation in stage three, the control system 400 may accelerate the WIG 100 by increasing the speeds of the propeller assemblies 116. The control system 400 may accelerate the WIG 100 to a desired takeoff speed. Because the WIG 100 is operating in a hydrofoil-borne mode at this point, the desired takeoff speed must be below the hydrofoil cavitation speed and is therefore significantly limited. In some examples, the desired takeoff speed is approximately 40 knots. However, as described above, by arranging the propeller assemblies 116 in a blown-wing configuration, the WIG 100 may generate additional lift that allows for takeoff at such low speeds.

Once the control system 400 determines that the WIG 100 has reached the desired takeoff speed, the control system 400 may deploy the flaps 118 (and the ailerons 120 if configured as flaperons), causing the wing 104 to generate additional lift. The control system 400 additionally actuates the rear foil control surfaces 140 and/or the elevators 126 in order to pitch the WIG 100 upward and increase the angle of attack of the wing 104 and the hydrofoil assemblies 108, 110. In this configuration, the wing 104 and hydrofoil assemblies 108, 110 create enough lift force to accelerate the WIG 100 upwards until the hydrofoil assemblies 108, 110 breach the surface of the water and the entire weight of the WIG 100 is supported by the lift of the wing 104.

In some examples, when performing this transition from hydrofoil-borne operation to wing-borne operation, the control system 400 may quickly deploy the flaps 118 (and the ailerons 120 if configured as flaperons) over a very short period of time (e.g., in less than 1 second, less than 0.5 seconds, or less than 0.1 seconds). Quickly deploying the flaps 118 (and ailerons 120) in this manner creates even further additional lift forces on the wing 104 that may help “pop” the WIG 100 out of the water and into wing-borne operation.

Additionally, during the transition from hydrofoil-borne operation to wing-borne operation, the control system 400 may actuate various control surfaces of the WIG 100 to balance moments along the pitch axis. For instance, the propeller assemblies 116, the flaps 118, and the drag from the hydrofoil assemblies 108, 110 all generate nose-down moments around the center of gravity about the pitch axis during transition. To counteract these forces, the control system 400 may deploy the elevator 126 and the rear foil control surfaces 140 to generate a nose-up moment and stabilize the WIG 100.

Once the transition from hydrofoil-borne operation to wing-borne operation is complete at stage three, the control system 400 may cause the main hydrofoil deployment system 200 and the rear hydrofoil deployment system 300 to respectively retract the main hydrofoil assembly 108 and the rear hydrofoil assembly 110. In practice, the control system 400 may initiate this retraction as soon as the hydrofoil assemblies 108, 110 are clear of the water in order to reduce the chance of the hydrofoil assemblies 108, 110 reentering the water. The control system 400 may determine that the hydrofoil assemblies 108, 110 are clear of the water in various ways. As one example, the control system 400 may make such a determination based on a measured altitude of the WIG 100 (e.g., based on data provided by the radar system 416, the lidar system 418, or the other sensors 422 described above for measuring an altitude of the WIG 100). As another example, the sensors 422 may further include one or more conductivity sensors, temperature sensors, pressure sensors, strain gauge sensors, or load cell sensors arranged on the hydrofoil assemblies 108, 110, and the control system 400 may determine that the hydrofoil assemblies 108, 110 are clear of the water based on data from these sensors.

Once the WIG 100 is clear of the water, the control system 400 can continue to accelerate the WIG 100 to a desired cruise velocity by controlling the speed of the propeller systems 116. The control system 400 may retract the flap systems when the WIG 100 has achieved sufficient airspeed to generate enough lift to sustain altitude without them. Additionally, the control system 400 can actuate the various control surfaces of the WIG 100 and/or apply differential thrust to the propeller systems 116 to perform any desired maneuvers, such as turning, climbing, or descending, and to provide efficient lift distribution. While in wing-borne mode, the WIG 100 can fly both low over the water's surface in ground-effect, or above ground-effect depending on operational conditions and considerations.

D. Return to Hull-Borne Operation

In order to transition to stage four, the control system 400 determines that the hydrofoil assemblies 108, 110 are fully retracted so that the WIG 100 may safely land on its hull 102. The control system 400 may additionally determine and suggest a desired landing direction and/or location based on observed, estimated, or expected water surface conditions (e.g., based on data from the radar system 416, the lidar system 418, the imaging system 420, or other sensors 422).

The control system 400 initiates deceleration of the WIG 100, for instance by reducing the speeds of the propeller systems 116, until the WIG 100 reaches a desired landing airspeed. During the deceleration, the control system 400 may deploy the flaps 118 to increase lift at low airspeeds and/or to reduce the stall speed. Once the WIG 100 reaches the desired landing airspeed (e.g., approximately 50 knots), the control system 400 reduces the descent rate (e.g., to be less than approximately 200 ft/min). As the WIG 100 approaches the surface of the water (e.g., once the control system 400 determines that the WIG 100 is within 5 feet of the water surface), the control system 400 further slows the descent rate to cushion the landing (e.g., to be less than approximately 50 ft/min). As the hull 102 of the WIG 100 impacts the surface of the water, the control system 400 reduces thrust, and the WIG 100 rapidly decelerates due to the presence of hydrodynamic drag, the reduction in forward thrust, and the reduction or elimination of blowing air over the wing which significantly reduces lift causing the vehicle to settle into the water. The hull 102 settles into the water as the speed is further reduced until the WIG 100 is stationary.

Once the WIG 100 is settled in the water, the WIG 100 may transition to stage five by extending the hydrofoil assemblies 108, 110 in order to transition from hull-borne operation to hydrofoil-borne operation in the same manner as described above. The control system 400 may then sustain the hydrofoil-borne mode at stage five and maneuver the WIG 100 into port while keeping the hull 102 insulated from surface waves. The WIG 100 may then transition to back to hull-borne operation in stage six when the control system 400 reduces the thrust generated by the propeller assemblies 116 to lower the speed of the WIG 100 until the hull 102 settles into the water. The control system 400 may then retract the hydrofoil assemblies 108, 110 and engage in hull-borne operation as described above to maneuver the WIG 100 into a dock for disembarking passengers or goods and recharging the battery system.

### IV. Example Wave State Analysis

As noted above, the control system 400 may include various sensor systems for controlling operation of the WIG 100, such as sensors in the GNSS system 412, the INS system 414, the radar system 416, the lidar system 418, the imaging system 420, and/or other sensors 422. Detailed examples of specific sensors that may be included in one or more of the above sensor systems are explained in further detail below. These sensors may be configured to generate various sensor data indicative of characteristics of the water surface below the WIG 100, and the control system 400 may use this sensor data as a basis for controlling operation of the WIG 100.

A. Focal Length Image Sensors

The WIG 100 may include one or more focal length image sensors configured to measure a distance between the WIG 100 and a surface of the body of water beneath the WIG 100. The focal length image sensors may have an adjustable focal length and may measure the distance between the WIG 100 and the surface of the body of water by adjusting the sensor focal length until the image is brought into focus, such that the focal length of the sensor matches the distance between the sensor and the water surface. As such, the control system 400 may determine the distance between the sensor and the water surface to be equal to the value of the focal length of the image sensor once the image sensor is brought into focus.

Each focal length image sensor may include a multi-pixel camera sensor configured to adjust its focal length using any currently known autofocus techniques, such as, for example, phase detection (PD) autofocus techniques, contrast detection (CD) autofocus techniques, or a hybrid of PD and CD techniques. When using any of these autofocus techniques, adjusting the focal length of the sensor to focus the image captured by the sensor may involve focus hunting in which the sensor starts with an initial focal length and then repeatedly adjusts the focal length, either in a sweeping or stepping manner, until the autofocus is achieved. For instance, when using PD autofocus techniques, a feedback loop may adjust the optical focal length about an initial guess and converge on the true focal length (i.e., the focal length that results in a focused image), which involves under-stepping and over-stepping the true focal length. Further, when using CD autofocus techniques, the focal length may be swept from one extrema towards the other, stopping once a maximum contrast is reached between neighboring pixels.

When using PD or CD autofocus techniques, the focus hunting described above may be relatively time-consuming, especially when the starting focal length is far from the true focal length. As a result, existing PD or CD autofocus techniques may not be suitable for measuring distances based on the focal length in the manner described above when the distances are rapidly changing. For instance, the present disclosure contemplates using the focal length image sensors to determine the distance between a water surface and a vehicle (e.g., the WIG 100) in motion over the water surface. In such a configuration, the speed of the vehicle and the magnitude and frequency of the waves at the water surface may cause the distance between the vehicle and the water surface to rapidly change. Accordingly, existing PD and CD autofocus techniques may not be capable of resolving this distance faster than the distance changes, thereby rendering such existing techniques unsuitable for this measurement.

To help address these issues, the technology disclosed herein uses prior distance measurements and/or distance measurements from one or more other sensors to intelligently predict an estimated value of the distance between the vehicle and the water surface. The focal length image sensors may then use this estimated value of the distance as the initial value of the focal length of the image sensors. Performing PD, CD, or a hybrid PD/CD autofocus technique starting from this initial value may drastically reduce the time it takes to resolve the true focal length and, therefore, determine the actual current distance between the vehicle and the water surface.

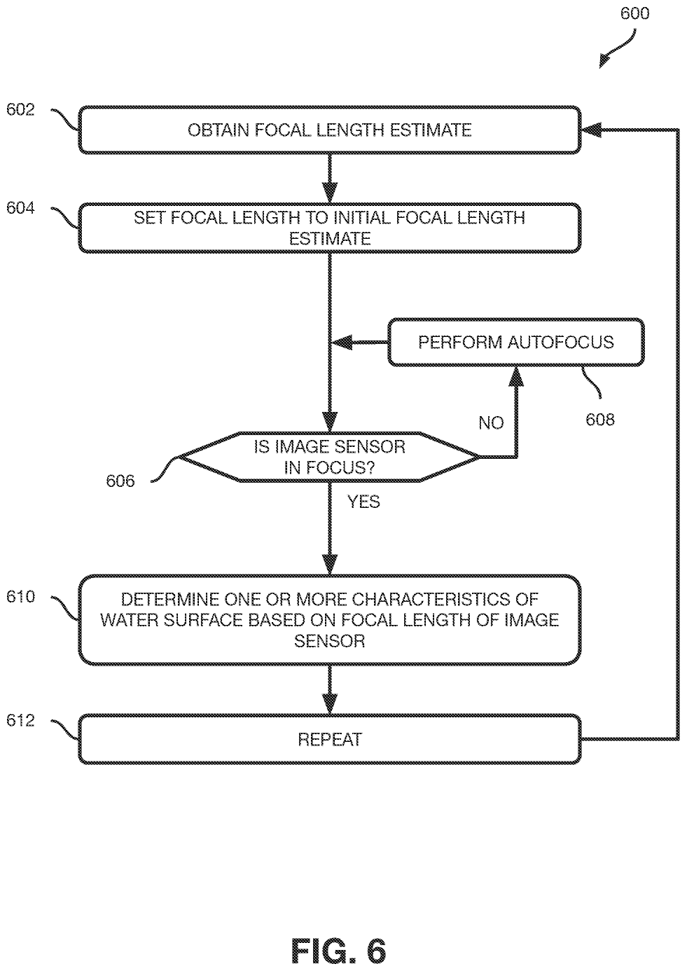

FIG. 6 depicts a flowchart 600 of example operations that may be carried out in connection with each of the focal length image sensors in order to determine various characteristics of the surface of a body of water, including the slope or shape of the water surface and/or the distance between the water surface and a vehicle (e.g., the WIG 100) in motion over the water surface. The example operations will be discussed with reference to a control system that may carry out the example operations. In this regard, the control system may be similar to or the same as the control system 400 of FIG. 4. The flowchart 600 may include one or more operations, functions, or actions as illustrated by one or more of blocks 602-612. Although blocks 602-612 are illustrated in sequential order, these blocks may also be performed in parallel, and/or in a different order than those described herein, where possible. Also, the various blocks may be combined into fewer blocks, divided into additional blocks, and/or removed based upon the desired implementation.

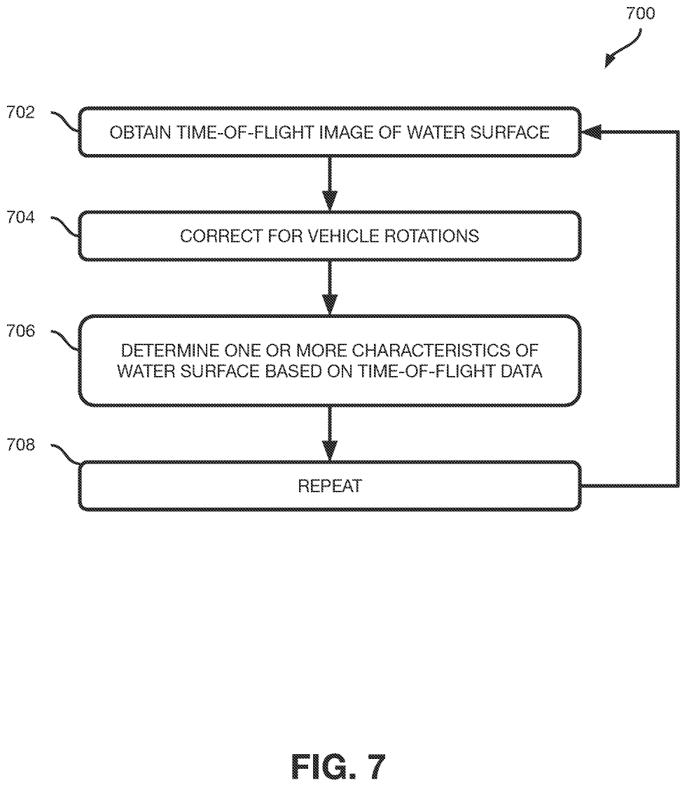

In addition, for the flowchart 600 and other processes and methods disclosed herein, including those depicted by flowcharts 700, 800, and 1000 described below in connection with FIGS. 7, 8, and 10, each flowchart shows functionality and operation of one possible implementation of present examples. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long-term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the flowcharts disclosed herein, each block shown may represent circuitry that is wired to perform the specific logical functions in the process.

Turning now to the operations of flowchart 600, at block 602, the control system may obtain an initial focal length estimate. During the first execution of the operations in flowchart 600, the control system may obtain the initial focal length estimate based solely on sensor data from sensors that are different from the focal length image sensors. For example, the control system may obtain sensor data from one or more IMUs indicating positional information of the vehicle, such as an altitude of the vehicle, and the control system may determine the initial focal length estimate to be equal to the altitude of the vehicle. In other examples, the control system may obtain sensor data from various other sensors as well, such as any of the distance measuring sensors described herein, and use the distance measurements from those sensors as the initial focal length estimate.

Alternatively, in some examples, the control system may cause the focal length image sensors to perform functions similar to traditional autofocusing techniques during the first execution of the operations in flowchart 600. For example, the control system may cause the focal length image sensors to choose a random, pseudorandom, or otherwise predetermined initial focal length value. Starting from this initial focal length value, the control system may then cause the focal length image sensors to iteratively adjust the focal length value using traditional autofocus techniques until the image captured by the focal length image sensor is focused. The control system may then treat this adjusted focal length value as the initial focal length estimate.

During second and subsequent execution of the operations in the flowchart 600, the control system will have access to previous distance measurements determined using the focal length image sensors as well as previous distance measurements determined using any of the other measurement techniques described herein, and the control system may additionally or alternatively use one or more of these previous measurements, such as one or more of the most recent distance measurements, to determine the initial focal length estimate. For instance, the control system may use a set of recent distance measurements to determine a slope or shape of the water surface, such as by fitting a curve to the distance measurements. Then, based on the altitude of the vehicle as determined by the IMU and the determined slope and/or shape of the water surface, the control system may estimate the distance between the vehicle and the water surface and use the estimated distance as the initial focal length estimate.

At block 604, the control system may set the focal length of the focal length image sensor to be equal to the initial focal length estimate. Setting the focal length may involve moving a lens of the image sensor, such as by controlling one or more servo motors coupled to the lens and causing the lens to move closer to or farther from a sensor array.

At block 606, the control system may determine whether the image sensor is in focus. In line with the discussion above, the control system may make this determination using any currently known or later developed autofocus techniques, such as, for example, using a PD technique, a CD technique, or a hybrid PD/CD technique. When using a PD technique, this may involve capturing two separate images using light that passes through the lens of the image sensor and comparing the images to determine a phase difference indicative of how focused the image is. When using a CD technique, this may involve determining an amount of contrast between adjacent pixels in the image.

If the control system determines that the image sensor is still out of focus, then the flowchart 600 advances to block 608 where the control system attempts to autofocus the image, such as, for example, by using a PD, CD, or hybrid PD/CD technique. When using a PD technique, this may involve moving the lens of the image sensor a particular distance that is determined based on the determined phase difference between the compared images at block 606. When using a CD technique, this may involve incrementally moving the lens a predefined distance in a predefined direction. The predefined direction may be a fixed direction, a randomly chosen direction, or a direction chosen based on a rate of change of the distance measurement. For instance, previous distance measurements may be compared to determine a rate of change of the distance measurement, which may correspond with a slope of the water surface. The control system may use the rate of change of the distance measurement to estimate a current distance between the image sensor and the water surface and/or to forecast a future distance between the image sensor and the water surface. Based on the estimated current distance or forecasted future distances, the control system may move the lens of the image sensor in a particular direction that causes the focal length of the image sensor to approach the estimated current distance or forecasted future distance.

After attempting to autofocus the image, the flowchart 600 returns to block 606 where the control system reevaluates whether the image sensor is in focus. When using a CD technique, the control system may need to repeatedly reposition the lens and evaluate the contrast of the image until peak contrast is reached and the image sensor is in focus.

Once the control system determines that the image sensor is in focus, then the flowchart 600 advances to block 610 where the control system determines one or more characteristics of the water surface based on the focal length of the image sensor. In some examples, the determined characteristics of the water surface may include a distance between the vehicle and the water surface, which the control system may determine to be the focal length of the image sensor once the image sensor has been focused at block 606.

The determined characteristics of the water surface may additionally include a slope, curvature, and/or shape of the water surface. For instance, as explained below in connection with block 612, the control system may repeatedly perform the process depicted in flowchart 600, thereby generating a data set defining multiple distances between the vehicle and the water surface over time. The frequency at which the control system repeatedly performs the process depicted in flowchart 600 may depend on the wave period of the water surface that the control system is attempting to resolve as well as the desired resolution of the measured characteristics of the water surface. For example, at a bare minimum, the control system may perform the process at a frequency corresponding to the Nyquist rate for the water surface (i.e., twice the frequency at which the WIG 100 encounters waves while traveling over the water surface), but the control system may perform the process at a higher frequency to improve the resolution of the measured characteristics. In some examples, this frequency may be a predefined frequency or may be set based on previous measurements and/or forecasted characteristics of the water surface. For instance, if previous distance measurements and/or forecasted distance measurements based on the previous distance measurements indicate that the frequency of the waves is increasing, then the control system may increase the rate at which it performs the process depicted in flowchart 600. Conversely, if previous distance measurements and/or forecasted distance measurements based on the previous distance measurements indicate that the frequency of the waves is decreasing, then the control system may decrease the rate at which it performs the process depicted in flowchart 600.

When performing the process depicted in flowchart 600, the control system may determine the slope, curvature, and/or shape of the water surface based on differences between the measured distances over time and the changes in vertical and horizontal position of the vehicle based on positional data from the vehicle's IMU. Examples of such shape data may include locations of wave crests on the water surface, locations of wave troughs on the water surface, an instantaneous or time-averaged height of the waves on the water surface, an instantaneous or time-averaged amplitude of the waves on the water surface, and/or a frequency or period of waves on the water surface based on the distances measured over time.

Further, the vehicle may include an array of focal length image sensors distributed across the underside of the vehicle, such as along the length of the vehicle's hull and/or the width of the vehicle's wingspan. With such an array of image sensors, the control system may perform the process depicted in flowchart 600 to determine the slope, curvature, and/or shape of the water surface along multiple axes corresponding to the axes of the sensor array.

At block 612, the control system returns to the beginning of the flowchart 600 to repeat the operations all over again. In this manner, the control system iteratively performs the operations of flowchart 600 to repeatedly and/or continually determine the characteristics of the wave surface using the focal length image sensors.

B. Time-of-Flight Sensors

The WIG 100 may include one or more time-of-flight (TOF) sensors configured to measure a distance between the WIG 100 and a surface of the body of water beneath the WIG 100. The TOF sensors may take various forms, an example of which may include lidar sensors. The TOF sensors may be arranged in an array for imaging an area of the water surface, with each sensor in the array configured to measure a distance to each pixel in the imaged area. An example of such a sensor array is a photonic mixer device (PMD), such as the PMD described in Ringbeck et al., “A 3D Time of Flight Camera for Object Detection,” Optical 3-D Measurement Techniques (2007). In a PMD, instead of scanning a single laser beam over an entire surface area to obtain the distance measurements of the area, the PMD illuminates the entire area with modulated light and observes the reflected light with an intelligent pixel array. Each pixel in the array can individually measure the turnaround time of the modulated light by using continuous modulation and measuring the phase delay in each pixel.

FIG. 7 depicts a flowchart 700 of example operations that may be carried out in connection with each of the TOF sensors in order to determine various characteristics of the surface of a body of water, including the slope or shape of the water surface and/or the distance between the water surface and a vehicle (e.g., the WIG 100) in motion over the water surface. The example operations will be discussed with reference to a control system that may carry out the example operations. In this regard, the control system may be similar to or the same as the control system 400 of FIG. 4. The flowchart 700 may include one or more operations, functions, or actions as illustrated by one or more of blocks 702-708. Although blocks 702-708 are illustrated in sequential order, these blocks may also be performed in parallel, and/or in a different order than those described herein, where possible. Also, the various blocks may be combined into fewer blocks, divided into additional blocks, and/or removed based upon the desired implementation.

Turning now to the operations of flowchart 700, at block 702, the control system may obtain a TOF image of the water surface, such as by using one or more PMDs. In line with the discussion above, the TOF image may identify a distance between the PMD sensor array and a plurality of points on the water surface corresponding to each pixel in the TOF image.

At block 704, the control system may adjust the distance measurements identified by the TOF image to correct for one or more rotations of the vehicle (e.g., roll, pitch, or yaw). In order for the TOF image to provide distance measurements that directly correspond to the height of the vehicle above the water surface, the sensor array should be substantially horizontal. Any rotations of the vehicle may likewise rotate the sensor array out of the horizontal plane, and the control system may apply one or more transformations to the TOF measurements to account for such rotations. For instance, the vehicle may include an IMU configured to measure the position and orientation of the vehicle, as noted above, and the control system may determine the extent of rotation of the vehicle about the roll, pitch, or yaw axes based on data from the IMU. The control system may then apply the appropriate transformation to the TOF measurements to compensate for the determined rotations of the vehicle.

At block 706, the control system may determine one or more characteristics of the water surface based on the corrected distance measurements from the TOF image. In some examples, the determined characteristics of the water surface may include a distance between the vehicle and the water surface, which the control system may determine by performing a statistical analysis to the distance measurements, such as, for example, by averaging the distance measurements across all pixels.

The determined characteristics of the water surface may additionally include a slope, curvature, and/or shape of the water surface. For instance, the control system may determine a local slope, curvature, and/or shape of the water surface from a single TOF image based on differences between the TOF measurements of two pixels in the TOF image (corresponding to a change in height of the water surface between the two pixels) and the horizontal distance between the two pixels. Further, in some examples, determining the shape of the water surface may involve determining the gradient of the TOF image. For instance, the control system may determine an approximation of the gradient at each pixel of the TOF image using the distance measurements of two or more pixels of the TOF image. However, these are just some examples of ways in which the control system may determine the slope, curvature, and/or shape of the water surface, and the control system may additionally or alternatively apply any other mathematical or statistical analyses to the TOF measurements that would indicate the shape of the water surface.

Further, as explained below in connection with block 708, the control system may repeatedly perform the process depicted in flowchart 700, thereby generating a data set defining the distances between the vehicle and the water surface over time. The control system may determine the slope, curvature, and/or shape of the water surface based on differences between the measured distances over time and/or space and the changes in vertical and horizontal position of the vehicle based on positional data from the vehicle's IMU or other spatial position and orientation sensors. Examples of such shape data may include locations of wave crests on the water surface, locations of wave troughs on the water surface, an instantaneous or time-averaged height of the waves on the water surface, an instantaneous or time-averaged amplitude of the waves on the water surface, and/or a frequency or period of waves on the water surface based on the distances measured over time.

Still further, the vehicle may include TOF sensor arrays distributed across the underside of the vehicle, such as along the length of the vehicle's hull and/or the width of the vehicle's wingspan. With multiple arrays of TOF sensors, the control system may determine the slope, curvature, and/or shape of the water surface over larger areas monitored by the multiple arrays of TOF sensors and/or may do so more accurately.

At block 708, the control system returns to the beginning of the flowchart 700 to repeat the operations all over again. In this manner, the control system iteratively performs the operations of flowchart 700 to repeatedly and/or continually determine the characteristics of the wave surface using the TOF sensors.

C. Wing Deflection Sensors

The WIG 100 may include one or more wing deflection sensors configured to measure various characteristics of a surface of the body of water beneath the WIG 100. As used herein, the term “wing deflection” may refer to any deflection of the wing from its unloaded configuration, or from some other nominal configuration, as well as any deformation of the wing from its unloaded or nominal configuration due to aerodynamic and/or hydrodynamic loading. The wing deflection sensors may take various forms and may include any sensor capable of measuring deflections of one or more wings of the WIG 100. Examples of such sensors may include: (i) strain gauges configured to measure the strain of the wings when the wings are deflected in an upward or downward direction, (ii) optical backscatter reflectometers configured to measure the deflections or bends in optical fibers run across the spans of the wings, or (iii) fiber Bragg gratings configured to measure the deflections or bends in optical fibers run across the spans of the wings. However, these examples are merely illustrative, and various other sensors capable of measuring wing deflection may be used in other examples.

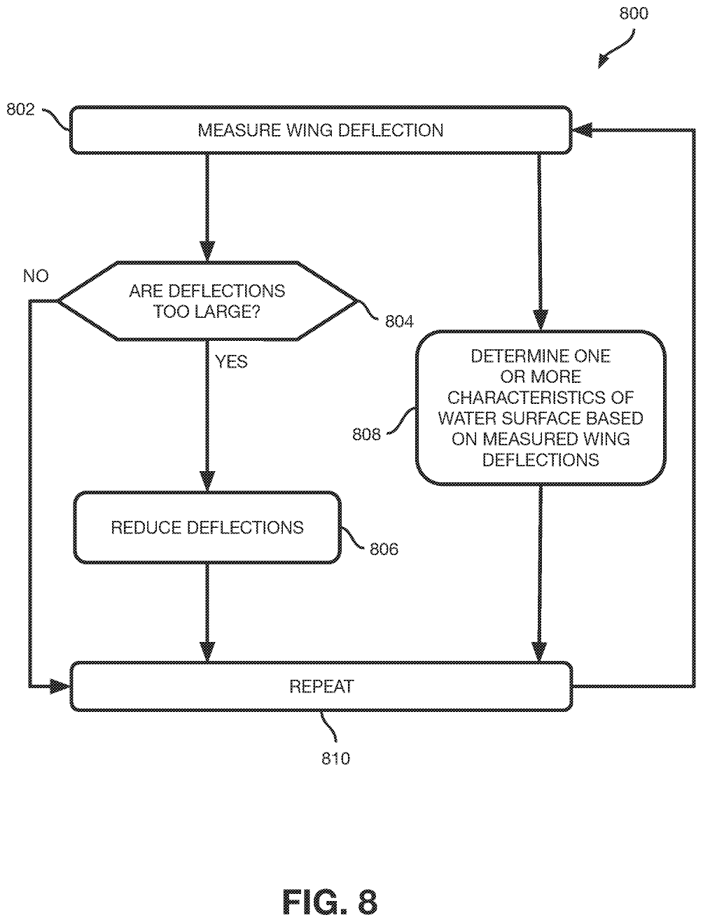

FIG. 8 depicts a flowchart 800 of example operations that may be carried out in connection with the wing deflection sensors in order to determine various characteristics of the surface of a body of water beneath a vehicle (e.g., the WIG 100) in motion over the water surface. The example operations will be discussed with reference to a control system that may carry out the example operations. In this regard, the control system may be similar to or the same as the control system 500 of FIG. 5. The flowchart 800 may include one or more operations, functions, or actions as illustrated by one or more of blocks 802-810. Although certain ones of blocks 802-810 are illustrated in a particular sequential or parallel order, these blocks may also be performed in a different sequential or parallel order than those described herein, where possible. Also, the various blocks may be combined into fewer blocks, divided into additional blocks, and/or removed based upon the desired implementation.

Turning now to the operations of flowchart 800, at block 802, the control system may measure a deflection of one or more wings of the vehicle using any of the wing deflection sensors described herein. Based on data from the wing deflection sensors, the control system may determine a magnitude of the deflection of the wing (e.g., a distance measurement in the form of an absolute or relative distance measurement) from a reference position. The reference position may be any predefined position, such as the position of the wing at rest (e.g., when not in motion in a quiescent fluid environment).

Wing deflection may be caused by various forces exerted on the wing. As one example, a wing operating in ground effect (i.e., near a rigid surface like the ground or near a free surface behaving similar to a rigid surface like a water surface) experiences a loading force distributed along the wing's span and chord, which generates a lift force. The lift force exerted on the wing while operating in ground effect is different than the lift force exerted on the wing while operating in an unbound fluid (e.g., at typical cruising altitudes of standard aircraft). For instance, while operating in ground effect, the lift force exerted on the wing and how it is distributed over the wing, depends on a distance between the wing and the surface providing the ground effect, such that the deflection of the wing may vary as the distance between the vehicle and the water surface varies. Further, rapid wing deflection may occur when operating in ground effect above a rapidly changing surface, such as when operating above a water surface with wave peaks and valleys. Again, because the distance between the wing and the ground surface affects the amount of lift force exerted on the wing, the presence of waves may cause this distance to vary as the vehicle traverses the waves and may therefore cause wing deflections that correspond to this varying distance.

At block 804, the control system may determine whether the measured wing deflections are so large that remedial action should be taken to reduce the deflections. Wing deflections may become too large when they are large enough to put the vehicle at risk of structural damage or large enough to create an unpleasant ride experience for passengers. For instance, high frequency deflections caused by the change in lift force resulting from peaks and valleys of waves beneath the vehicle may induce vibrations in the vehicle that, if large enough, create an unpleasant ride experience, increase the risk of structural damage to the vehicle, or interfere with the ability to control or safely operate the vehicle. In order to determine whether the measured deflections are too large, the control system may compare the measured deflections to a predetermined value. If the magnitude of the deflections exceeds the predetermined value, then the flowchart 800 may advance to block 806, and the control system may take action to reduce the wing deflections. If, on the other hand, the magnitude of the deflections does not exceed the predetermined value, then the flowchart 800 may advance to block 810, and the control system may refrain from taking action to reduce the wing deflections.

At block 806, the control system may reduce the wing deflections in various ways. The action taken by the control system may depend on the type and/or magnitude of the measured wing deflections. For example, as noted above, the amount of lift force exerted on the wing and how the lift force is distributed may depend on the distance between the wing and the water surface. Namely, reducing the distance between the wing and the water surface may increase the lift force, and increasing the distance between the wing and the water surface may decrease the lift force. As such, in order to reduce or alter the nature of the wing deflection, the control system may increase the distance between the wing and the water surface, and the control system may do so by adjusting one or more control surfaces of the vehicle to increase the vehicle's altitude.

As another example, the wing deflections may occur at a particular frequency that is likely to cause excessive vibration and/or mechanical fatigue of the vehicle. For instance, due to the structural composition of the vehicle, there may be one or more resonant frequencies at which induced vibrations caused by rapid wing deflections may experience positive feedback and continue to grow until the magnitude of the wing deflections and/or the vibrations exceeds a threshold magnitude. In such a scenario, the control system may take action to alter the frequency of the wing deflections in order to distance the deflection frequency from the resonant frequency of the vehicle. For example, the control system may be configured to increase or decrease a velocity of the vehicle, as this may increase or decrease the frequency at which the vehicle travels over the waves of the water surface and thus increases or decreases the frequency of the wing deflections. As another example, the control system may be configured to change a heading of the vehicle, as this may similarly increase or decrease the frequency at which the vehicle travels over the waves of the water surface and thus increases or decreases the frequency of the wing deflections.

When increasing the vehicle's altitude and/or changing the velocity and/or heading of the vehicle in order to reduce the wing deflections, the control system may be configured to do so by a predetermined amount or until the magnitude of the deflections no longer exceed the predetermined value. As shown in the flowchart 800, this may be an iterative process in which, after attempting to reduce the magnitude of the wing deflections at block 806, the control system remeasures the wing deflection at block 802 and reevaluates whether the deflections are too large at block 804.

Further, in some or all of the example scenarios described above, the control system may be configured to display to an operator of the vehicle, such as the pilot of the WIG 100, an indication that the measured wing deflections are too large. The operator may then interact with the control system, such as by using the control effectors 426, to adjust and altitude and/or velocity of the vehicle to reduce the magnitude of the measured wing deflections.

In parallel with the operations described above in connection with blocks 804 and 806 for reducing wing deflections, at block 808, the control system may determine one or more characteristics of the water surface based on the measured wing deflections. In some examples, the determined characteristics of the water surface may include a distance between the vehicle and the water surface. As noted above, the magnitude of the measured wing deflection may depend on the distance between the vehicle and the water surface. As such, the control system may determine the distance between the vehicle and the water surface based on the magnitude of the measured wing deflection. The precise relationship between the magnitude of the wing deflection and the distance between the vehicle and the water surface may depend on a number of factors, such as the shape and material of the wings. Therefore, the control system may need to be calibrated beforehand using experimental data that correlates the magnitude of the wing deflection to the distance between the vehicle and the water surface. Such calibration data may be stored in a data storage of the control system, such that the control system may access the calibration data for comparison with the measured wing deflection to determine the distance between the vehicle and the water surface.

The determined characteristics of the water surface may additionally include a slope or shape of the water surface. For instance, as explained below in connection with block 810, the control system may repeatedly perform the process depicted in flowchart 800, thereby generating a data set defining multiple distances between the vehicle and the water surface over time. The control system may determine the slope or shape of the water surface based on differences between the measured distances over time and the changes in vertical and horizontal position of the vehicle based on positional data from the vehicle's IMU. Examples of such shape data may include locations of wave crests on the water surface, locations of wave troughs on the water surface, an instantaneous or time-averaged height of the waves on the water surface, an instantaneous or time-averaged amplitude of the waves on the water surface, and/or a frequency or period of waves on the water surface based on the distances measured over time.

Further, in some examples, the determined characteristics of the water surface may include a frequency and/or period of the waves on the water surface. In line with the discussion above, changes in the height of the water surface due to the presence of waves may induce changes in the deflection of the wings, such that the frequency and period of the wing deflections may correspond to the frequency and period of the waves. As such, the control system may determine the frequency and period of the waves to be the frequency and period, respectively, of the measured wing deflections.

At block 810, the control system returns to the beginning of the flowchart 800 to repeat the operations all over again. In this manner, the control system iteratively performs the operations of flowchart 800 to repeatedly and/or continually determine the characteristics of the wave surface using the wing deflection sensors.

D. Distributed Sensor Array

Some or all of the sensors described herein may be distributed across the planform of the vehicle, such as in an array, in order to provide multiples spatially-distinct measurements. Such an arrangement of the sensors may allow for noise reduction and for resolving directionality. Noise reduction may be accomplished by means of spatial averaging techniques, which may include weighted spatial averaging techniques. Spatial averaging of the sensor data may be performed across the multiple sensors concurrently, thereby avoiding challenges with real-time temporal filtering end effects. Directionality of the waves can be resolved by correlating measurements taken at distinct spatial locations. Estimates of the vehicle and wave propagation directions can be used, in conjunction with an application of the total derivative, to provide a spatially-consistent predicted measurement of the water surface.

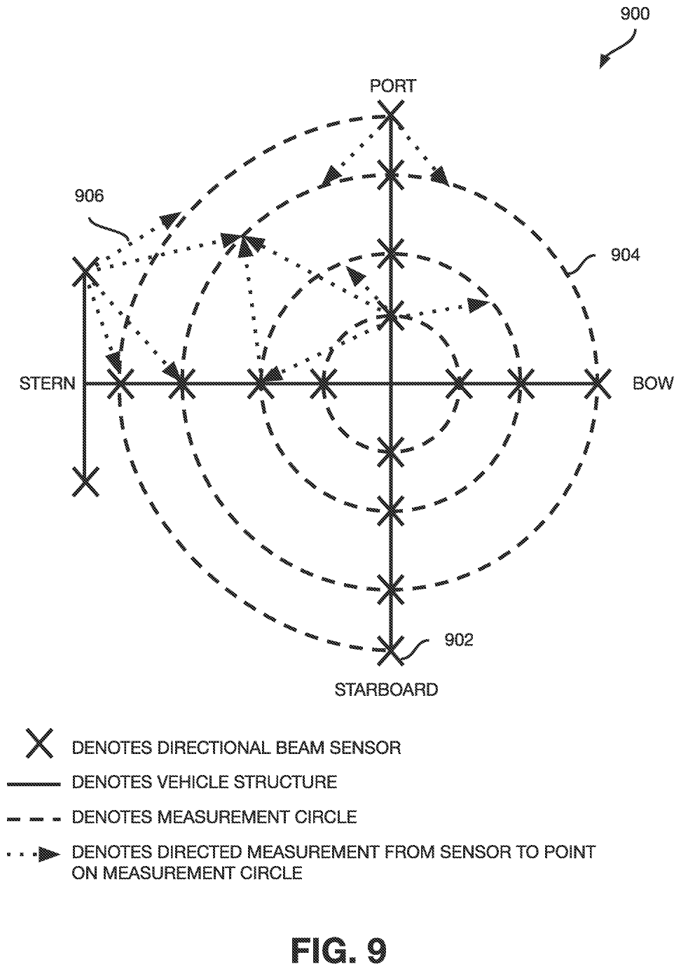

FIG. 9 depicts an example distributed sensor array 900 that may be implemented in connection with the WIG 100. As shown, the sensors 902 may be arranged in a pattern that is as close to uniformly-spaced in a circular manner as possible to resolve angular variations in the wave-vehicle heading. The sensors 902 may be arranged in several projections of a circle 904 with the same focus and/or different foci. An uneven radial spacing of sensors 902 may provide the best potential to avoid aliasing phenomena. The radial spacing may be implemented according to Chebychev-Gauss-Lobatto (cosine) spacing for use with orthogonal polynomial interpolants or random radial lines for Fourier or spline bases.

The sensors 902 may be implemented as directional and steerable sensors 902 and may be arranged such that the sensors 902 are capable of targeting different locations 906 along circular or cartesian patterns 904 underneath the vehicle. The use of an array and phased signals, which may or may not contain overlapping frequency components, can be used to measure the distance to the water surface at multiple positions in space beneath the vehicle. These measurements may be combined to resolve slopes of the water surface, and/or averaged or fused to reduce noise in the measurements.

In some examples, the sensors 902 that can directly measure surface gradients, such as the TOF image sensors described above, may be placed near the center of the vehicle, while the sensors 902 that can take point measurements, such as the focal length image sensors, may placed both near the center and extremities of the vehicle. Placing sensors capable of directly measuring surface gradients near the center of the vehicle may provide more accurate measurements, as there may be less variability in the distance between the center of the vehicle and the water surface than between the extremities of the vehicle and the water surface. Further, the center of the vehicle is typically the lowest point of the vehicle and may therefore be the most critical position for measuring the distance between the vehicle and the water surface for purposes of avoiding collision with the water surface.

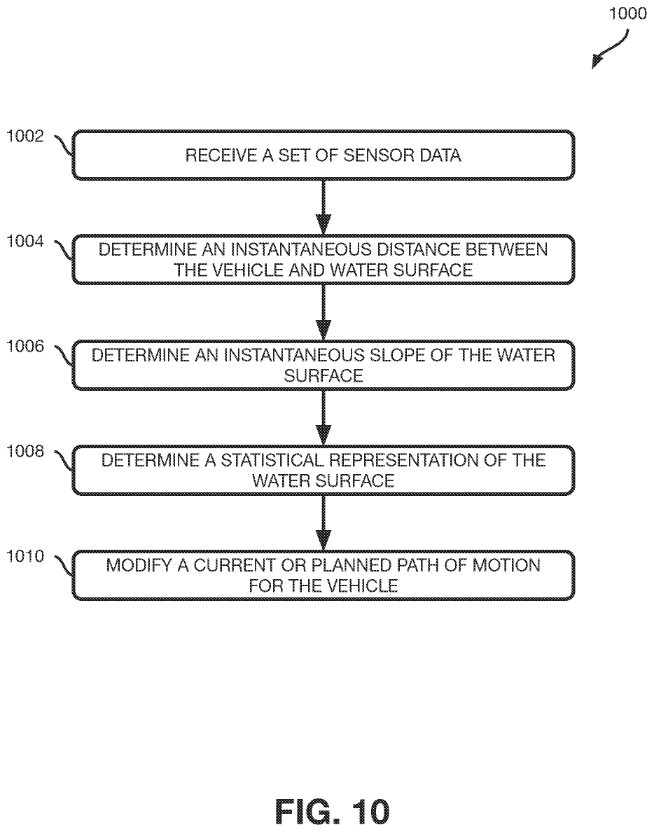

However, it should be appreciated that other configurations are possible as well. For instance, in some examples, other components of the vehicle, such as the outriggers 114 may extend below the hull, especially during certain maneuvers such as those that involve banked turns or when landing. Accordingly, in some examples, it may be more critical to measure the distance between the outriggers 114 or other components of the vehicle and the water surface. This may be accomplished by placing one or more of the sensors described herein on such components in order to directly measure the distance between such components and the water surface. Additionally or alternatively, the control system may be provisioned with data defining the locations of these extremities of the vehicle in 3D space (e.g., relative to the positions of the sensors). Then, based on the distance measurements obtained from the sensors and a determined orientation of the vehicle (e.g., based on IMU data), the control system may determine distances between these critical extremities of the vehicle and the water surface. As described below in connection with FIG. 10, the control system may then control the motion of the vehicle to make sure these extremities do not make unwanted contact with the water surface.

### V. Example Vehicle Control Based on Wave State Analysis

FIG. 10 depicts a flowchart 1000 of example operations that may be carried out in connection with a vehicle (e.g., the WIG 100) in motion over a water surface. The example operations will be discussed with reference to a control system that may carry out the example operations. In this regard, the control system may be similar to or the same as the control system 500 of FIG. 5. The flowchart 1000 may include one or more operations, functions, or actions as illustrated by one or more of blocks 1002-1010. Although blocks 1002-1010 are illustrated in sequential order, these blocks may also be performed in parallel, and/or in a different order than those described herein, where possible. Also, the various blocks may be combined into fewer blocks, divided into additional blocks, and/or removed based upon the desired implementation.

Turning now to the operations of flowchart 1000, at block 1002, the control system may receive a set of sensor data from one or more sensors of the vehicle. The one or more sensors may include any of the sensors described herein for measuring various characteristics of the water surface, such as one or more of the focal length image sensors, one or more of the TOF image sensors, and/or one or more of the wing deflection sensors.

At block 1004, based on the set of sensor data, the control system may determine an instantaneous distance between the vehicle and the water surface. In examples where the one or more sensors include an image sensor having an adjustable focal length, the control system may determine the instantaneous distance between the vehicle and the water surface by adjusting the focal length of the image sensor until the image captured by the sensor is in focus (e.g., using any of various autofocusing techniques), such that the focal length of the image sensor matches the distance between the image sensor and the water surface. The set of sensor data in such examples may include a value of the focal length of the sensor, and the control system may determine the instantaneous distance between the vehicle and the water surface to be equal to the focal length of the image sensor after the focal length has been adjusted to bring the captured image into focus.

As further described above, adjusting the focal length of the image sensor may involve using historical data indicative of one or more previously measured characteristics of the wave surface to estimate a current characteristic of the wave surface. For instance, the control system may adjust the focal length based on a previously determined slope of the water surface, which may have been determined using any of the techniques described below in connection with block 1006. In some examples, if the previously measured slope indicates that the water surface is rising along a direction of travel of the vehicle, then the control system may decrease the focal length of the image sensor from its previous value. Alternatively, if the previously measured slope indicates that the water surface is falling along a direction of travel of the vehicle, then the control system may increase the focal length of the image sensor from its previous value. The amount that the control system increases or decreases the focal length of the sensor may depend on the steepness of the slope and the speed of the vehicle. For instance, the control system may determine a horizontal distance traveled by the vehicle since the previous slope measurement based on the vehicle's speed and/or based on data from an IMU of the vehicle, and the control system may multiply the distance traveled by the previously measured slope of the water surface to estimate the change in height of the water surface since the previous measurement. The control system may then increase or decrease the focal length of the image sensor a specific amount that compensates for this estimated change in height of the water surface.

In examples where the one or more sensors include one or more of the TOF image sensors described herein, which are configured to measure a respective TOF for each pixel of a plurality of pixels of an image captured by the image sensor (e.g., a PMD sensor), the set of sensor data received from the TOF image sensor may include a respective TOF value for each respective pixel of the plurality of pixels. In such examples, the control system may determine a respective instantaneous distance between the vehicle and the water surface for each pixel of the TOF image sensor using each pixel's TOF value in any of the manners described above.

In examples where the one or more sensors include one or more of the wing deflection sensors described herein, the set of sensor data received from the one or more wing deflection sensors may include data indicating a magnitude of the deflection of one or more wings of the vehicle. In such examples, determining the instantaneous distance between the vehicle and the surface of the body of water comprises determining the instantaneous distance in any of the manners described above.

At block 1006, further based on the set of sensor data, the control system may determine an instantaneous slope of the water surface. The control system may determine the instantaneous slope of the water surface based on multiple instantaneous distance measurements determined using any of the techniques described above in connection with block 1004 of the flowchart 1000. For instance, the control system may determine multiple instantaneous distances between the vehicle and the water surface, including at least a first instantaneous distance and a second instantaneous distance. The control system may then determine the instantaneous slope of the water surface based on a difference between the first and second instantaneous distances. For instance, the control system may determine the instantaneous slope by dividing the difference between the first and second instantaneous distances by a horizontal distance between the points on the water surface where the first and second instantaneous distances were measured.

In some examples, the first and second instantaneous distances may be consecutive distance measurements made using a single sensor, such as consecutive measurements made using one of the focal length image sensors or one of the wing deflection sensors. In other examples, the first and second instantaneous distances may be concurrent measurements made using a single sensor. For instance, the first and second instantaneous distances may respectively correspond to two different distance measurements determined using the TOF data for two different pixels of one of the TOF image sensors.

Further, in some examples, the control system may determine the instantaneous slope of the water surface based on more than just two instantaneous distance measurements. For instance, the control system may determine several instantaneous distance measurements over time, apply a curve fitting technique to a set of recent distance measurements, and determine the slope of the water surface based on the slope of the fitted curve. Additionally or alternatively, in line with the discussion above, when using a TOF image sensor to concurrently measure a plurality of distances over a pixel area, the control system may determine an instantaneous slope at each pixel of the area by determining a gradient of the measured distances. Other examples are possible as well.

At block 1008, the control system may determine a statistical representation of the water surface based on at least one of the instantaneous distance or slope measurements. In some examples, determining the statistical representation of the water surface may include determining, for the body of water, at least one of a time-averaged wave height, a time-averaged wave amplitude, a wave height variance, a wave amplitude variance, a wave frequency, or a mean free surface of the body of water.

As described above in connection with FIGS. 6-8, when measuring the distance between the vehicle and the water surface using any of the sensors described herein, the control system may repeatedly make these measurements over time and correlate these measurements with a position of the vehicle to resolve different characteristics of the water surface. For instance, at any given time, the control system may determine a position and orientation of the vehicle in three-dimensional (3D) space based on data obtained from an IMU of the vehicle. Based on the vehicle's known position and orientation in 3D space and the determined distance between the vehicle and a point on the water surface, the control system may likewise determine where that point on the water surface lies in 3D space. And by rapidly repeating this process over time for many points across the water surface, the control system may generate a map of data points corresponding to positions of the water surface in 3D space. The control system may then apply various statistical analyses to this data to determine any of the statistical representations of the water surface identified above, or various other statistical representations as well. Further, in some examples, the control system may identify, based on the 3D map of the water surface, certain water surface features and their locations in 3D space, such as the locations of wave crests and wave troughs.

Still further, based on the various characteristics of the water surface that the control system directly measures using the techniques described above, the control system may predict various characteristics of approaching areas of the water surface along the direction of travel of the vehicle. For instance, the control system may determine trends in the measured characteristics of the water surface and project those trends along the vehicles direction of travel to estimate the same characteristics in the approaching areas of the water surface.

At block 1010, the control system may modify a current or planned path of motion for the vehicle based on one or more of the measurements described above, such as the instantaneous distance measurements, the instantaneous slope measurements, the statistical representations of the water surface, the 3D map of the water surface, and/or the locations of various water surface features. In some examples, this may involve the control system modifying the path of motion based on forecasted characteristics of the water surface determined using any of the measurements described above. For instance, in line with the discussion above, the control system may use data from the sensors to predict the slope, curvature, and/or shape of the water surface that the vehicle is expected to encounter, such as by forecasting characteristics of approaching areas of the water surface along the direction of travel of the vehicle. As such, the control system may preemptively modify the path of motion and/or one or more operational parameters of the vehicle in anticipation of encountering such characteristics.

In some examples, the control system may modify a current path of motion for the vehicle in order to maintain a desired altitude of the vehicle above the water surface. For example, if the vehicle is in airborne flight or in hydrofoil-borne travel with the hull raised above the water surface, it may be advantageous to maintain an altitude at which the vehicle (e.g., the entire vehicle when in flight, or the hull of the vehicle when hydrofoiling) avoids contacting the water surface while still keeping the vehicle close to the water surface for other operational considerations (e.g., to maintain ground effect for a WIG in flight, or to ensure that the hydrofoil remains submerged for a hydrofoil-borne vehicle).

To facilitate this, the control system may determine a target distance between the vehicle and the water surface. The target distance may be a predefined distance that may be specified by an operator of the vehicle via user input. The target distance may be relative to various different features of the water surface. As one example, the target distance may be a target distance between the vehicle and the mean free surface of the water. As another example, the target distance may be a target distance between the vehicle and the peak height (e.g., a wave crest) of the water surface. Other examples are possible as well.

Using any of the techniques described above, the control system may measure the actual distance between the vehicle and the various features of the water surface and compare the actual distance to the target distance. For instance, the control system may measure the actual distance between the vehicle and the mean free surface of the water and compare this measurement to the target distance between the vehicle and the mean free surface of the water. Additionally or alternatively, the control system may measure the actual distance between the vehicle and the water surface at its peak height and compare this measurement to the target distance between the vehicle and the water surface at its peak height.

Based on the difference between the actual distance and the target distance, the control system may adjust one or more control surfaces of the vehicle in order to modify the motion of the vehicle until the actual distance matches the target distance. For instance, the control system may adjust one or more elevators, ailerons, and/or flaps of the wings and/or hydrofoils of the vehicle to increase or decrease the altitude of the vehicle until the actual distance matches the target distance.

In examples where the sensor technology described herein is implemented in connection with a WIG similar to the WIG 100 described herein, the control system may use any of the measured characteristics of the water surface as a basis for controlling transitions between different modes of operation of the WIG, such as when transitioning from hydrofoil-borne mode to airborne mode or when transitioning from airborne mode to hull-borne mode.

When transitioning from hydrofoil-borne mode to airborne mode, it is desirable for the WIG's hydrofoil to quickly break free of the water surface and to remain free without making subsequent contact, which could result in damage to the hydrofoil or, even worse, cause the vehicle to crash into the water. One way to reduce or eliminate the chances of the hydrofoil making subsequent contact with the water surface after breaking free from the water is to cause the hydrofoil to break free from the water at or near a wave crest, as this is the highest point of the water surface. Breaking free from the water surface at its highest point and then continuing to increase in altitude in airborne mode may greatly reduce the chance of the hydrofoil striking a subsequent wave after breaking free from the water.

To achieve this, the control system may determine the locations of wave crests on the water surface using any of the techniques described above and may identify a particular location of a wave crest at which the WIG's hydrofoil is to break free from the water surface. Based on the current location of the WIG (e.g., based on IMU data or other positional data) and the known location of the hydrofoil relative to the WIG, the control system may then adjust a speed of the WIG and/or one or more control surfaces of the WIG, such as one or more elevators, ailerons, and/or flaps of the wings and/or hydrofoils of the WIG, in a manner that causes the hydrofoil to break free from the water surface at or near the identified location of the wave crest.

When transitioning from airborne mode to hull mode (i.e., when landing the WIG on a water surface), it may be desirable for the WIG's hull to initiate contact with the water at a particular water surface feature. The particular feature may vary depending on the design of the WIG, but may include a wave trough, or an upward or downward slope of a wave.

In order to cause the WIG to transition from airborne mode to hull mode at a desirable water surface feature, the control system may determine the locations of the desirable water surface features using any of the techniques described above and may identify a particular location of a desirable water surface feature at which the WIG's hull is to make contact with the water surface. Based on the current location of the WIG and the known orientation of the hull (e.g., based on IMU data or other positional data), the control system may then adjust a speed of the WIG and/or one or more control surfaces of the WIG, such as one or more elevators, ailerons, and/or flaps of the wings of the WIG, in a manner that causes the hull to make initial contact with the water surface at or near the identified location of the desirable water feature.

Additionally or alternatively, in response to identifying a particular location of a desirable water surface feature at which the WIG's hull is to make contact with the water surface, the control system may cause a display of the WIG to present a visual indication of the identified location to an operator of the WIG, such that the operator may manually land the WIG at the identified location, such as by using the control effectors 426.

### VI. Conclusion

The above detailed description describes various features and functions of the disclosed WIGs, sensor systems, and methods of operation with reference to the accompanying figures. While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A computing system comprising:
at least one processor;
non-transitory computer-readable medium; and
program instructions stored on the non-transitory computer-readable medium that are executable by the at least one processor such that the computing system is configured to:
receive, from one or more sensors of a vehicle in motion over a body of water, a set of sensor data;
based on the set of sensor data, determine (i) an instantaneous distance between the vehicle and a surface of the body of water and (ii) an instantaneous slope of the surface of the body of water;
based on at least one of the instantaneous distance or the instantaneous slope, determine a statistical representation of the surface of the body of water; and
based on the determined statistical representation of the surface of the body of water, adjust one or more control surfaces of the vehicle to change one or more of a speed, altitude, heading, or attitude of the vehicle.

2. The computing system of claim 1, further comprising program instructions stored on the non-transitory computer-readable medium that are executable by the at least one processor such that the computing system is configured to modify a motion plan of the vehicle based on at least one of the instantaneous distance, the instantaneous slope, or the statistical representation of the surface of the body of water.

3. The computing system of claim 1, further comprising program instructions stored on the non-transitory computer-readable medium that are executable by the at least one processor such that the computing system is configured to adjust one or more of the control surfaces of the vehicle based on at least one of the instantaneous distance, the instantaneous slope, or the statistical representation of the surface of the body of water.

4. The computing system of claim 1, wherein determining the statistical representation of the surface of the body of water comprises determining, for the body of water, at least one of a time-averaged wave height, a time-averaged wave amplitude, a wave height variance, a wave amplitude variance, a wave frequency, or a mean free surface of the body of water.

5. The computing system of claim 1, wherein determining the statistical representation of the surface of the body of water comprises determining a mean free surface of the body of water, and wherein the computing system further comprises program instructions stored on the non-transitory computer-readable medium that are executable by the at least one processor such that the computing system is configured to determine a distance between the vehicle and the mean free surface of the body of water.

6. The computing system of claim 5, further comprising program instructions stored on the non-transitory computer-readable medium that are executable by the at least one processor such that the computing system is configured to compare the distance between the vehicle and the mean free surface of the body of water to a target distance, wherein adjusting the one or more control surfaces of the vehicle comprises adjusting the one or more control surfaces of the vehicle based on a difference between the target distance and the distance between the vehicle and the mean free surface of the body of water.

7. The computing system of claim 1, wherein the instantaneous distance between the vehicle and the surface of the body of water is a first instantaneous distance,
wherein the computing system further comprises program instructions stored on the non-transitory computer-readable medium that are executable by the at least one processor such that the computing system is configured to determine a second instantaneous distance between the vehicle and the surface of the body of water, and
wherein determining the instantaneous slope of the surface of the body of water comprises determining the instantaneous slope of the surface of the body of water based on a difference between the first instantaneous distance and the second instantaneous distance.

8. The computing system of claim 1, wherein the one or more sensors comprise an image sensor having an adjustable focal length,
wherein the set of sensor data comprises a value of the focal length,
wherein the computing system further comprises program instructions stored on the non-transitory computer-readable medium that are executable by the at least one processor such that the computing system is configured to adjust the focal length of the image sensor to match a distance between the image sensor and the surface of the body of water, and
wherein determining the instantaneous distance between the vehicle and the surface of the body of water comprises determining the instantaneous distance based on the adjusted focal length of the image sensor.

9. The computing system of claim 8, wherein adjusting the focal length of the image sensor comprises:
determining a previously measured slope of the surface of the body of water; and
adjusting the focal length of the image sensor based on the previously measured slope of the surface of the body of water by (i) decreasing the focal length of the image sensor if the previously measured slope indicates that the surface is rising along a direction of travel of the vehicle or (ii) increasing the focal length of the image sensor if the previously measured slope indicates that the surface is falling along the direction of travel of the vehicle.

10. The computing system of claim 1, wherein the one or more sensors comprise an image sensor configured to measure a respective time-of-flight for each pixel of a plurality of pixels of an image captured by the image sensor,
wherein the set of sensor data comprises a respective time-of-flight value for each respective pixel of the plurality of pixels, and
wherein determining the instantaneous distance between the vehicle and the surface of the body of water comprises determining a respective instantaneous distance between the vehicle and the surface of the body of water for each respective time-of-flight value.

11. The computing system of claim 10, wherein determining the instantaneous slope of the surface of the body of water comprises determining the instantaneous slope of the surface of the body of water based on a difference between a first one of the determined respective instantaneous distances and a second one of the determined respective instantaneous distances.

12. The computing system of claim 1, wherein the one or more sensors comprise one or more sensors configured to measure a deflection of one or more wings of the vehicle, wherein the set of sensor data comprises data indicating the deflection of the one or more wings, and wherein determining the instantaneous distance between the vehicle and the surface of the body of water comprises determining the instantaneous distance based on the data indicating the deflection of the one or more wings.

13. A non-transitory computer-readable medium, wherein the non-transitory computer-readable medium is provisioned with program instructions that, when executed by at least one processor, cause a computing system to:
receive, from one or more sensors of a vehicle in motion over a body of water, a set of sensor data;
based on the set of sensor data, determine (i) an instantaneous distance between the vehicle and a surface of the body of water and (ii) an instantaneous slope of the surface of the body of water;
based on at least one of the instantaneous distance or the instantaneous slope, determine a statistical representation of the surface of the body of water; and
based on the determined statistical representation of the surface of the body of water, adjust one or more control surfaces of the vehicle to change one or more of a speed, altitude, heading, or attitude of the vehicle.

14. The non-transitory computer-readable medium of claim 13, wherein the non-transitory computer-readable medium is also provisioned with program instructions that, when executed by at least one processor, cause the computing system to modify a motion plan of the vehicle based on at least one of the instantaneous distance, the instantaneous slope, or the statistical representation of the surface of the body of water.

15. The non-transitory computer-readable medium of claim 13, wherein the non-transitory computer-readable medium is also provisioned with program instructions that, when executed by at least one processor, cause the computing system to adjust one or more of the control surfaces of the vehicle based on at least one of the instantaneous distance, the instantaneous slope, or the statistical representation of the surface of the body of water.

16. The non-transitory computer-readable medium of claim 13, wherein determining the statistical representation of the surface of the body of water comprises determining, for the body of water, at least one of a time-averaged wave height, a time-averaged wave amplitude, a wave height variance, a wave amplitude variance, a wave frequency, or a mean free surface of the body of water.

17. The non-transitory computer-readable medium of claim 13, wherein determining the statistical representation of the surface of the body of water comprises determining a mean free surface of the body of water, and wherein the computing system further comprises program instructions stored on the non-transitory computer-readable medium that are executable by the at least one processor such that the computing system is configured to determine a distance between the vehicle and the mean free surface of the body of water.

18. The non-transitory computer-readable medium of claim 17, wherein the non-transitory computer-readable medium is also provisioned with program instructions that, when executed by at least one processor, cause the computing system to compare the distance between the vehicle and the mean free surface of the body of water to a target distance, wherein adjusting the one or more control surfaces of the vehicle comprises adjusting the one or more control surfaces of the vehicle based on a difference between the target distance and the distance between the vehicle and the mean free surface of the body of water.

19. The non-transitory computer-readable medium of claim 13, wherein the instantaneous distance between the vehicle and the surface of the body of water is a first instantaneous distance,
wherein the non-transitory computer-readable medium is also provisioned with program instructions that, when executed by at least one processor, cause the computing system to determine a second instantaneous distance between the vehicle and the surface of the body of water, and
wherein determining the instantaneous slope of the surface of the body of water comprises determining the instantaneous slope of the surface of the body of water based on a difference between the first instantaneous distance and the second instantaneous distance.

20. A method performed by a computing system, the method comprising:
receiving, from one or more sensors of a vehicle in motion over a body of water, a set of sensor data;
based on the set of sensor data, determining (i) an instantaneous distance between the vehicle and a surface of the body of water and (ii) an instantaneous slope of the surface of the body of water;
based on at least one of the instantaneous distance or the instantaneous slope, determining a statistical representation of the surface of the body of water; and
based on the determined statistical representation of the surface of the body of water, adjusting one or more control surfaces of the vehicle to change one or more of a speed, altitude, heading, or attitude of the vehicle.
